(19) United States
(12) Patent Application Publication
(10) Pub. No.: US 2020/0286021 A1
(43) Pub. Date: Sep. 10, 2020

(54) METHODS AND SYSTEMS FOR COORDINATING LOCAL DELIVERIES

(71) Applicant: United States Postal Service, Washington, DC (US)

(72) Inventor: Ryan M. Luckay, Vienna, VA (US)

(21) Appl. No.: 16/810,145

(22) Filed: Mar. 5, 2020

Related U.S. Application Data
(60) Provisional application No. 62/814,475, filed on Mar. 6, 2019.

(51) Int. Cl. G06Q 10/06; G06Q 10/08; G06Q 10/04; G01C 21/34

(52) U.S. Cl. CPC G06Q 10/06315; G06Q 10/0832; G06Q 10/06312; G01C 21/343; G06Q 10/0834; G06Q 10/0833; G06Q 10/047; G06Q 10/08355

(57) ABSTRACT

Methods and systems for coordinating item delivery are disclosed. In one aspect, a method comprises receiving a request to transport an item and identifying a delivery vehicle based on a proximity of the delivery vehicle to the pickup location. The method further comprises determining whether the identified delivery vehicle is associated with a first delivery service or a second delivery service. When the identified delivery vehicle is associated with the first delivery service, the method comprises generating a notification to the identified delivery vehicle that an itinerary and a routing of the identified vehicle have been updated. When the identified delivery vehicle is associated with the second delivery service, the method comprises generating an inquiry to the identified vehicle requesting confirmation that the identified vehicle will transport the item and receiving a response. The method also comprises generating a confirmation including an identifier of the identified delivery vehicle.

### CROSS-REFERENCE TO RELATED APPLICATIONS

This application claims priority benefit to U.S. provisional Application No. 62/814,475, filed on Mar. 6, 2019 and entitled “METHODS AND SYSTEMS FOR COORDINATING LOCAL DELIVERIES”, which is incorporated by reference herein in its entirety for all purposes.

### FIELD

This disclosure relates to dynamic coordinating and routing of delivery vehicles, and in particular, to dynamic coordinating and routing that satisfies constraints relating to items being transported.

### BACKGROUND

On-demand delivery services are becoming more commonplace. Many service providers offer on-demand transportation that can satisfy real-time demands quickly and efficiently, albeit at enhanced cost. As on-line ordering continues to swell, as third-party transportation services become more prevalent, and as local purchasing makes a resurgence, consumers have available and grow increasingly reliant on on-demand transportation services and customizable delivery services for various goods. Therefore, additional techniques of providing customizable delivery services are needed.

### SUMMARY

In one aspect described herein, a method of coordinating item delivery, comprises receiving a request to transport an item, the request including at least one of a pickup location and a delivery location; identifying a delivery vehicle of a plurality of delivery vehicles based on a proximity of the delivery vehicle to the pickup location; determining whether the identified delivery vehicle is associated with a first delivery service or a second delivery service; when the identified delivery vehicle is associated with the first delivery service: generating a notification to the identified delivery vehicle that the pickup location has been added to an itinerary of the identified delivery vehicle, and updating a routing of the identified vehicle based on the pickup location and the delivery location; when the identified delivery vehicle is associated with the second delivery service: generating a first inquiry to the identified vehicle requesting confirmation that the identified vehicle will transport the item, and receiving a response to the first generated inquiry; and generating a confirmation including an identifier of the identified delivery vehicle.

In some embodiments, the request further indicates one or more of: an urgency or priority of the item; a requested delivery time for the item; transportation constraints for the item; and a value of the item.

In some embodiments, the transportation constraints for the item include: a size of the item; a weight of the item; environmental constraints of the item; and privacy constraints of the item.

In some embodiments, identifying the delivery vehicle is further based on filtering the plurality of delivery vehicles according to at least one of the urgency or priority of the item, the requested delivery time for the item, the transportation constraints for the item, and the value of the item.

In some embodiments, the request further includes a selection of the first delivery service or the second delivery service and wherein identifying the delivery vehicle is further based on the selection of the first or second delivery service.

In some embodiments, when the selection identifies the first delivery service, the identified delivery vehicle is identified from a first subset of the plurality of delivery vehicles, the first subset including only vehicles associated with the first delivery service, and when the selection identifies the second delivery service, the identified delivery vehicle is identified from a second subset of the plurality of delivery vehicles, the second subset including only vehicles associated with the second delivery service.

In some embodiments, identifying the delivery vehicle further comprises identifying one or both of the pickup location and the delivery location along a route of the identified delivery vehicle.

In some embodiments, the response includes a rejection indicating that the identified delivery vehicle rejects the inquiry and, further comprising, in response to the received rejection: identifying a second delivery vehicle of the plurality of delivery vehicles based on a proximity of the second delivery vehicle to the pickup location; determining whether the second identified delivery vehicle is associated with the first delivery service or the second delivery service; when the second identified delivery vehicle is associated with the first delivery service: generating a notification to the second identified delivery vehicle that the pickup location has been added to an itinerary of the second identified delivery vehicle, and updating a routing of the second identified vehicle based on the pickup location and the delivery location; when the second identified delivery vehicle is associated with the second delivery service: generating a second inquiry to the second identified vehicle requesting confirmation that the second identified vehicle will transport the item, and receiving a second response to the second generated inquiry.

In some embodiments, the method further comprises generating location updates for the identified delivery vehicle before and after pickup of the item.

In some embodiments, the method further comprises determining a minimum deviation route of the identified delivery vehicle based on an original route of the identified delivery vehicle and updating the original route to include the minimum deviation route.

In another aspect described herein, a system for coordinating item delivery, the system comprising: a communication component configured to receive a request to transport an item, the request including at least one of a pickup location and a delivery location; a processor circuit configured to: identify a delivery vehicle of a plurality of delivery vehicles based on a proximity of the delivery vehicle to the pickup location; determine whether the identified delivery vehicle is associated with a first delivery service or a second delivery service; when the identified delivery vehicle is associated with the first delivery service: generate a notification to the identified delivery vehicle that the pickup location has been added to an itinerary of the identified delivery vehicle, and update a routing of the identified vehicle based on the pickup location and the delivery location; when the identified delivery vehicle is associated with the second delivery service: generate a first inquiry to the identified vehicle requesting confirmation that the identified vehicle will transport the item, and receiving a response to the first generated inquiry; and generate a confirmation including an identifier of the identified delivery vehicle.

In some embodiments, the request further indicates one or more of: an urgency or priority of the item; a requested delivery time for the item; transportation constraints for the item; and a value of the item.

In some embodiments, the transportation constraints for the item include: a size of the item; a weight of the item; environmental constraints of the item; and privacy constraints of the item.

In some embodiments, the processor circuit configured to identify the delivery vehicle comprises the processor circuit configured to filter the plurality of delivery vehicles according to at least one of the urgency or priority of the item, the requested delivery time for the item, the transportation constraints for the item, and the value of the item.

In some embodiments, the request further includes a selection of the first delivery service or the second delivery service and wherein identifying the delivery vehicle is further based on the selection of the first or second delivery service.

In some embodiments, when the selection identifies the first delivery service, the identified delivery vehicle is identified from a first subset of the plurality of delivery vehicles, the first subset including only vehicles associated with the first delivery service, and when the selection identifies the second delivery service, the identified delivery vehicle is identified from a second subset of the plurality of delivery vehicles, the second subset including only vehicles associated with the second delivery service.

In some embodiments, the processor circuit configured to identify the delivery vehicle comprises the processor circuit configured to identify one or both of the pickup location and the delivery location along a route of the identified delivery vehicle.

In some embodiments, the response includes a rejection indicating that the identified delivery vehicle rejects the inquiry and wherein the processor circuit is further configured to, in response to the received rejection: identify a second delivery vehicle of the plurality of delivery vehicles based on a proximity of the second delivery vehicle to the pickup location; determine whether the second identified delivery vehicle is associated with the first delivery service or the second delivery service; when the second identified delivery vehicle is associated with the first delivery service: generate a notification to the second identified delivery vehicle that the pickup location has been added to an itinerary of the second identified delivery vehicle, and updating a routing of the second identified vehicle based on the pickup location and the delivery location; when the second identified delivery vehicle is associated with the second delivery service: generating a second inquiry to the second identified vehicle requesting confirmation that the second identified vehicle will transport the item, and receiving a second response to the second generated inquiry.

In some embodiments, the processor circuit is further configured to generate location updates for the identified delivery vehicle before and after pickup of the item.

In some embodiments, the processor circuit is further configured to determine a minimum deviation route of the identified delivery vehicle based on an original route of the identified delivery vehicle and updating the original route to include the minimum deviation route.

Methods and apparatuses or devices disclosed herein each have several aspects, no single one of which is solely responsible for its desirable attributes. Without limiting the scope of this disclosure, for example, as expressed by the claims that follow, its more prominent features will now be discussed briefly. After considering this discussion, and particularly after reading the section entitled “Detailed Description” one will understand how the described features provide advantages that include data authentication services.

### BRIEF DESCRIPTION OF THE DRAWINGS

These drawings and the associated description herein are provided to illustrate specific embodiments of the invention and are not intended to be limiting.

FIG. 1 is an overview diagram of a geographic region in which a localized delivery system is implemented.

FIG. 2 is an exemplary block diagram of the localized delivery system.

FIG. 3 shows exemplary table structures for relational databases of FIG. 2.

FIG. 4 is a flowchart of an exemplary method for satisfying a localized transportation request within the localized delivery system.

FIG. 5 is a flowchart of an exemplary method of coordinating localized transportation of an object using the localized delivery system.

FIG. 6 is a flowchart of a method for identifying stops within a threshold distance of a location associated with a user request.

FIG. 7 is a block diagram of an exemplary device for performing one or more of the methods described herein.

FIG. 8 is a block diagram of an exemplary delivery vehicle.

FIG. 9A is a flowchart of an exemplary method for processing a localized transportation request.

FIG. 10 is a flowchart of an exemplary method for selecting a vehicle to perform item transportation according to the localized transportation request.

FIG. 11 is a flowchart of an exemplary method of updating delivery management system (DMS) metrics for a vehicle in the system.

FIG. 12 is a flowchart of an exemplary process of handling a user request for localized transportation of an item.

### DETAILED DESCRIPTION

In today's world, consumers are generally able to buy goods and/or services from various merchants for delivery to a specified location. Sometimes, such deliveries may be coordinated through particular vendors (for example, the United States Postal Service (USPS®), Uber®, PostMates®, a courier, or a similar on-demand item delivery vendor). In many instances, the delivery services are coordinated through the merchant. For example, the consumer may opt to purchase an item from a merchant that contracts with the USPS to ship the item to the consumer. The consumer may choose same day delivery or a delayed delivery. For same day delivery services, the USPS, having many agents that service a geographic area in a given day (for example, handling mail items that are distributed between senders and receivers on a daily basis) may coordinate delivery of the item from the merchant to the consumer using one or more of these agents based on availability to accept and deliver the item according to various constraints. For example, in coordinating the delivery of the item to the consumer from the merchant may consider the routes of the agents, the space in the agents' vehicles, contractual limits (for example, hours worked, miles traveled, etc.) for the agents, and so forth when setting up the same day delivery. If USPS agents are not available for delivery, or if quicker delivery may be available from one of the third party vendors, the USPS systems may coordinate with one of the third party vendors to transport the item from the merchant to the consumer. Different systems, as described herein, may be used to coordinate delivery using one or more of a first party agent (for example, the USPS agent) and the third party agent (for example, the Uber® agent).

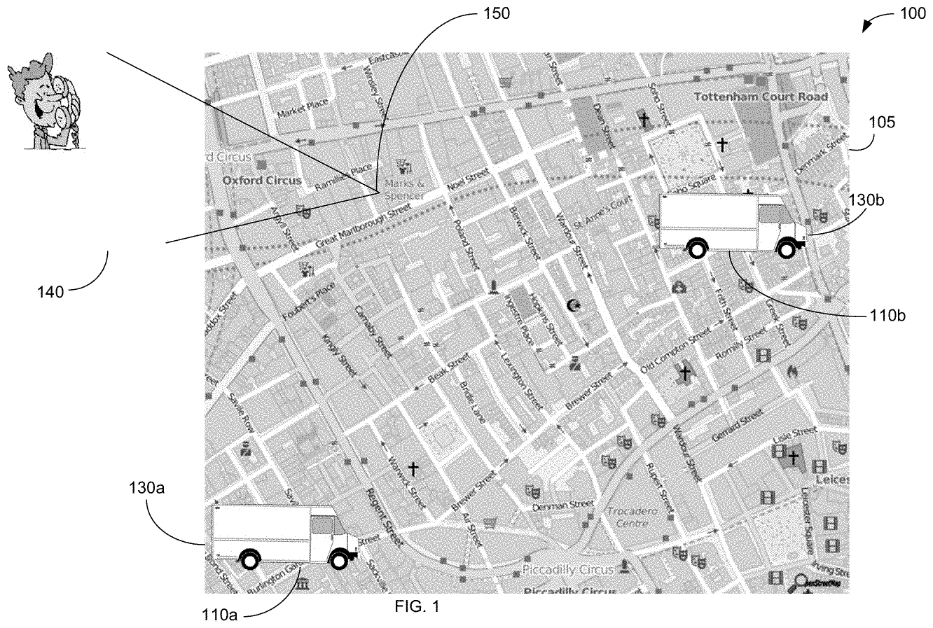

FIG. 1 is an overview diagram of a geographic region 105 in which a localized delivery system (not shown) is implemented. The delivery system 100 comprises or utilizes an automated system, a software interface, or a live attendant, for example. The delivery system 100 includes a plurality of delivery vehicles 110a-b traveling over the geographic region 105. At any particular time, a first delivery vehicle 110a (for example a first-party vehicle 110a) may be located at a first position 130a while a second delivery vehicle 110b (for example a third-party vehicle 110b) may be located at a second position 130b. In some embodiments, the plurality of delivery vehicles 110a-b are part of one or more transportation services and travel according to one or more delivery routes that are static and predetermined or dynamic and variable. In some embodiments, one or more other delivery vehicles 110 become available or one or more of the delivery vehicles 110a-b become unavailable dynamically while the delivery system 100 is operating.

While the vehicles 110a-b are located at the positions 130a-b and/or traveling along their corresponding delivery routes (not shown), a customer 140 may contact the delivery system 100 operating in the geographic region 105, to request or coordinate a pickup and/or delivery of an item or good. In some embodiments, the customer 140 may contact the delivery system 100 via a mobile computing device (not shown), for example via an application or a web browser on a smartphone, via another computing device (for example, a desktop computer, and so forth), via a phone call, and so forth. In some embodiments, the customer 140 may contact the delivery system 100 via a merchant, supplier, or broker, who has access to the delivery system 100. The coordinated pickup and/or delivery may include one or more of a pick-up of the item or good from a first location (such as a location of the customer 150) and delivery of the item or good to a second location. In some embodiments, the coordinated pickup and/or delivery does not involve the customer location 150. The coordinated pickup and delivery may include customer preferences and/or specific time constraints, geography constraints, vehicle size constraints, transportation constraints, and the like. For example, the customer 140 may request pickup and/or delivery by a certain time of day, transportation along a certain route, transportation by a particular transportation mode, or method, transportation of a perishable item, or transportation of a large or irregularly shaped item which cannot fit in every vehicle 110a-b.

The disclosed methods and systems may determine whether a delivery vehicle 110 (for example, one of the delivery vehicles 110a-b) of one of the available transportation and/or delivery services that service the geographic region 105 can satisfy the customer's request. The determination may be based on a number of conditions, such as an availability of the vehicles 110 (for example, from the various transportation and delivery services), the current locations of each of the vehicles 110a-b, the planned routes through the geographic region 105 of the vehicles 110a-b, the locations (for example, pickup and delivery locations) involved in the customer's request, item size, item type, customer preferences or specific constraints, among other conditions. By considering a variety of factors, the disclosed methods and systems may efficiently and effectively satisfy the request of the customer 140.

The disclosed methods and systems can be used on a local level, such as depicted in FIG. 1, and/or can be used on a city or town level, a county level, a state level, a regional level, a national level, or with any desired geographic area.

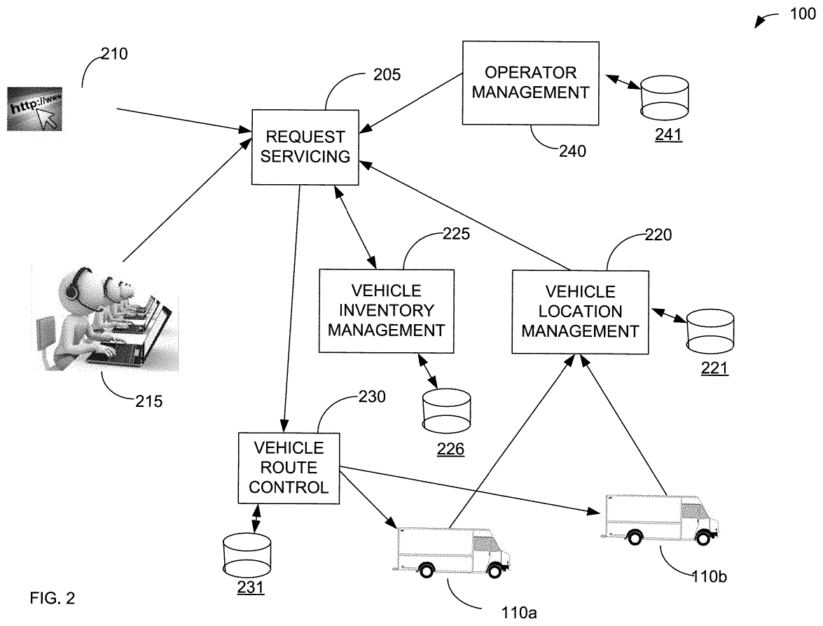

FIG. 2 is an exemplary block diagram of the delivery system 100. The delivery system 100 includes a request servicing component 205, comprising one or more of a networked computer system, a server, or similar system configured to receive requests from customers and process those requests electronically. The request servicing component 205 may receive one or more requests from a customer, such as customer 140 discussed above with respect to FIG. 1. In some aspects, the request(s) may be received via a computer portal or interface 210, such as a website, an internet-enabled computing device, a software application, a smartphone, or the like. In some aspects, the request may be received from a call center 215, with the customer 140 calling into the call center 215 to indicate their request, or in person, with the customer 140 traveling to a physical location (not shown) to present their request. Any of the components described herein in relation to the delivery system 100 may comprise one or more of a network computer system, a server, or a similar system configured to perform the described operation of the associated component(s).

To satisfy the request, the request servicing component 205 may interact with a vehicle location management component 220, a vehicle inventory management component 225, a vehicle route control component 230, and an operator management component 240. In some embodiments, the request servicing component 205 may filter vehicles received from the vehicle location management component 220 based on information received from the vehicle inventory management component 225, the vehicle route control component 230 and the operator management component 240.

In some embodiments, the vehicle location management component 220 may identify available vehicles 110 within the geographic region 105 serviced by the request servicing component 205. The vehicle location management component 220 may receive vehicle location updates from delivery vehicles 110a-b and may store the location information in a vehicle database 221. Although two vehicles 110a-b are depicted as vans or delivery trucks, the term vehicles 110 can indicate any number of vehicles and any type of vehicle, including, for example, trains, watercraft, and aircraft. The vehicle location information may then be provided to the request servicing component 205 as needed.

In some embodiments, the vehicle location management component 220 may integrate with one or more transportation or delivery services (for example a transportation network company, or rideshare company, such as Uber® or Lyft®, or a courier company, such as FedEx® or UPS®) to identify available vehicles and locations from each of the integrated transportation or delivery services. As such, the vehicle location management component 220 may identify vehicles from the one or more transportation network companies and/or vehicles from the courier companies that are within the geographic region 105 and may utilize the identified vehicles from the integrated transportation network and/or delivery services when fulfilling the request from the customer 140.

Furthermore, the vehicle location management component 220 may identify those vehicles 110 that are nearest one or both of item pickup and delivery locations. These particular vehicles 110 (in nearest proximity to one or both of the item pickup and delivery locations) may be presented as most viable options for the user request currently being coordinated. In some embodiments, the vehicle location management component 220 may also track locations for each vehicle 110 that is currently associated with the delivery system 100 for example, any vehicle 110 that is currently transporting an item according to a user request, as coordinated by the delivery system 100. For example, both the vehicles 110a-b may provide their locations to the vehicle location management component 220. The vehicle locations may be determined via GPS or any similar location determining means when the vehicles 110a-b are transporting an item for the delivery system 100 or are otherwise associated with the delivery system 100.

In some embodiments, the vehicle location management component 220 may track one or more attributes regarding the vehicles 110a-b, such as a vehicle identifier, a vehicle location, a vehicle route identifier, a next stop identifier, a rating, vehicle services, and a vehicle association. In some embodiments, one or more of these attributes may be used to filter vehicles 110a-b for use in fulfilling the user request for item transportation. In some embodiments, the vehicle location management component 220 may receive information from one or more third-party services to thereby receive location information for third-party vehicles. In some embodiments, when the third-party vehicles are transporting an item according to a received user request, the vehicle location management component 220 may receive location information directly from the third-party vehicles.

The vehicle inventory management component 225 may track inventory of items in each of the vehicles 110a-b. For example, one or more of the vehicles 110a-b may carry inventory from one or more user requests. The vehicle inventory management component 225 may track any items being transported in fulfillment of a user request in all vehicles 110a-b. In some embodiments, the vehicle inventory management component 225 may automatically add and remove (for example, update) items from the tracked inventory as new customer requests are received and as existing requests are completed or terminated with item delivery or removal from the vehicles 110.

The request servicing component 205 may consult the vehicle inventory management component 225 to determine which vehicles 110a-b have items in their respective inventory (for example, which vehicles 110a-b are transporting items in fulfillment of an existing user request). In some embodiments, the request servicing component 205 may determine that one or more vehicles 110a-b are not available based on the inventory of the one or more vehicles 110a-b (for example, when the inventory for the vehicle 110 indicates that the vehicle 110 is full or does not have capacity for additional items).

The vehicle inventory management component 225 may store inventory information in an inventory database 226 or in another database. In some embodiments, the inventory database 226 may be the same database as the vehicle database 221, or vice versa. In some embodiments, the vehicle inventory management component 225 may also track when the vehicles 110a-b have sufficient space for items, when the dimensions of the items to be transported are provided with the request. For example, if the items to be transported are a set of skis or a bicycle, the vehicle inventory management component 225 may determine whether the vehicles 110a-b have sufficient space or a correct size for those items even if the item inventories of those vehicles 110a-b are not full. In some embodiments, items may require specific criteria, such as environmental controls. The vehicle inventory management component can take environmental controls and other criteria into account.

The vehicle route control component 230 may store, monitor, and update a designated route of the vehicles 110a-b based on the pickup and delivery locations(s) of the user request. For example, each of the vehicles 110a-b may travel within the geographic region 105 according to a route that is stored in and monitored by the vehicle route control component 230. In some embodiments, the vehicle route control component 230 may work in conjunction with the vehicle location management component 220 to monitor the routes for the vehicles 110a-b. In some embodiments, if the vehicle route control component 230 determines that a vehicle 110 is off its route by a threshold amount, the vehicle route control component 230 may generate an alarm or an alert.

In some embodiments, the vehicle route control component 230 may monitor routes for all first-party vehicles 110a and all third-party vehicles 110b that are transporting items according to user requests. Furthermore, the vehicle route control component 230 may update existing routes for the vehicles 110a-b based on a selection of the vehicles 110a-b to fulfill a user request for transportation of an item. In some embodiments, the first- and third-party vehicles may be treated or handled similarly by the delivery system 100. For example, when the first-party vehicle 110a selected to complete a received user request has its route controlled by a navigation system or software, the vehicle route control component 230 adds the pickup and/or delivery location(s) as one or more of waypoints, intermediate destinations, or continuing destinations into an existing vehicle route. For example, when added as waypoints or intermediate destinations, the pickup and/or delivery location(s) are added as one or more stops along the existing vehicle route of the first-party vehicle 110a to its original destination. When added as the continuing destinations, the pickup and/or delivery location(s) may be added as one or more stops to be traveled to after the existing vehicle route of the first-party vehicle 110a to its original destination is complete.

In some embodiments, the determination of whether to add the pickup and/or delivery location(s) as waypoints or intermediate destinations or as continuing destinations is based on an impact adding these locations would have on an efficiency of the existing vehicle route or an impact adding these locations would have on travel time, arrival time, distance, etc., of the first-party vehicle 110a to its ultimate destination and any timing constraints of transporting the item per the user request. In some embodiments, the vehicle route control component 230 may generate a new route with a threshold minimum deviation from the existing vehicle route, wherein the threshold minimum route includes a deviation that is less than a threshold value. In some embodiments, the threshold value may change based on the vehicles identified as being available to transport the item, as will be explained in further detail herein.

In some embodiments, updating the existing vehicle route may comprise obtaining the existing vehicle route from a navigation or similar system of the vehicle 110 when the vehicle is the first-party vehicle 110a or the third-party vehicle 110b. In some embodiments, updating of the vehicle route may only occur after the vehicle 110 accepts the transportation of the item (for example, for the third-party vehicle 110b) or is assigned the transportation of the item (for the first-party vehicle 110a).

The vehicle route control component 230 may then provide the updated route information to the selected delivery vehicle 110, such as the delivery vehicles 110a-b. The vehicle route control component 230 may store vehicle route information in a route database 231. This process will be described in greater detail below.

Selection of the vehicle 110 by the request servicing component 205 to satisfy a user request may be based on various aspects of the user request and/or of the vehicle 110. For example, selection of the vehicle 110 may be based on the operator of the vehicle 110, such as whether the vehicle 110 is a first-party vehicle 110a or a third-party vehicle 110b. The first-party vehicle 110a may be associated with the delivery system 100 and may provide pickup and/or delivery services based on terms of a contract. In some aspects, the contract specifies a maximum deviation of vehicle operator work day lengths or scheduled routes specified by an employer of the operators. For example, there may be limits on a number of hours or an amount of work beyond a contracted amount that the operators are allowed to work. Alternatively, or additionally, there may be limits on a distance that an operator and corresponding vehicle is able to travel. In some embodiments, these maximum deviations include maximum time or maximum distance deviations from the original or scheduled routes. The maximum deviation for a particular operator and/or vehicle may be stored in an operator database 241. The operator management component 240 may consult the operator database 241 to determine maximum deviations allowed under contract for one or more operators/vehicles 110 for consideration by the request servicing component 205 in assigning the user request. This information may be used when selecting the first-party vehicle 110a, and thus an operator, to perform a particular user request. The selection may ensure, in some aspects, that assigning a particular on-demand request (i.e., the item pickup and/or delivery request) to a particular vehicle/operator will not violate the terms of the corresponding contract, as defined by the operator database 241. In some embodiments, the operator database 241 may be the same database as one or both of the vehicle database 221 and the inventory database 226 or another database.

The operator management system may determine to select a first-party vehicle 110a or a third-party vehicle 110b based on a proximity of each (or a respective route) to one or more of a pickup location associated with the received request and/or a route for the received request. In some embodiments, as described in further detail below, the operator management component 240 may select a third-party vehicle 110b over a first-party vehicle 110a and entice the third-party vehicle 110b to accept the request that the third-party vehicle 110b would otherwise refuse.

Operators of the first-party vehicle 110a provide pickup and delivery and/or pick-up services based on terms of the contract. In some aspects, as noted above, the contracts specify a maximum deviation of operators' work days or scheduled routes specified by an employer of the operators, which defines a number of hours or an amount of work beyond a contracted amount that the operators are allowed to work. The maximum deviation for a particular operator may be stored in an operator database 241. The operator management component 240 may consult the operator database 241 to determine maximum deviations allowed under contract for one or more operators as requested by the request servicing component 205. In some embodiments, these maximum deviations include maximum time or maximum distance deviations from the original or scheduled routes. This information may be used when selecting the first-party vehicle 110a to perform a particular user request. As described herein, the discussion of vehicles and operators will be inclusive, such that discussion of the vehicle corresponds to the operator of the vehicle, and vice versa. The selection may ensure, in some aspects, that assigning a particular on-demand request to a particular vehicle/operator will not violate the terms of the operator's employment contract, as defined by the operator database 241. In some embodiments, the operator database 241 may be the same database as one or both of the vehicle database 221 and the inventory database 226 or another database.

On the other hand, operators of the third-party vehicles 110b may themselves make a determination regarding whether or not they accept a particular user request. In some embodiments, the third-party vehicles 110b may consider a cost or price associated with the user request and compare that to other options for revenue (for example, a value proposition for the user request as compared to the other options). In some embodiments, when determining whether to accept the user request as provided by the operator management component 240 of the delivery system 100, the third-party vehicle 110b considers one or more of the value proposition of the user request, a desire to build a relationship with the delivery system 100, and any contractual relationships between the delivery system 100 and the third-party vehicle 110b and/or the third-party service with which the third-party vehicle 110b is associated. Similarly, when assigning the user request to the third-party vehicle 110b, the operator management component 240 may also analyze one or more of the cost of assigning the user request to the third-party vehicle 110b, the desire to build the relationship with the third-party vehicle 110b or the third-party service, and so forth.

In some embodiments, selection of the vehicle 110 by the request servicing component 205 is made based on a priority of the user request. For example, the received request may be assigned a priority that is compared with a predetermined or dynamic priority threshold. When the received request has a priority exceeding the threshold, the operator management component 240 may select between a first-party vehicle 110a and a third-party vehicle 110b based on the priority alone. For example, when the user request has a priority that exceeds the threshold, the operator management component 240 prioritizes (for example, first attempts to assign the user request to) the third-party vehicle 110b which is closer to the route or pickup location for the user request even if the first-party vehicle 110a is available at a lower cost. Alternatively, or additionally, when the user request has a priority that exceeds the threshold, the operator management component 240 prioritizes (for example, first attempts to assign the user request to) the third-party vehicle 110b, which is not restricted with regard to hours, distance, etc., for purposes of assigning the user request. In some embodiments, the operator management component 240 prioritizes the third-party vehicle 110b only when all first-party vehicles 110a are not available. Additionally, or alternatively, user requests having priorities that exceed the threshold may be assigned based on feedback of the vehicles, on-time performance of the vehicle, etc.

In some embodiments, when the user request priority is below the threshold, the operator management component 240 may prioritize or default to the first-party vehicle 110a unless no first-party vehicle 110a is available, for example, due to time or distance limitations, full vehicle, time of day, and so forth.

When the operator management component 240 prioritizes the third-party vehicle 110b, the operator management component 240 may consider one or more of the value proposition of the user request, a desire to build a relationship with the delivery system 100, and any contractual relationships between the delivery system 100 and the third-party vehicle 110b and/or the third-party service with which the third-party vehicle 110b is associated. For example, if the priority of the user request exceeds the threshold by a sufficient margin, then the operator management component 240 increases an amount to be paid to the third-party vehicle 110b to ensure that the user request is accepted. The increase is the amount to be paid to the third-party vehicle 110b may also be impacted or influenced by one or more of the contractual relationship between the delivery system 100 and the third-party service and/or the desire to build the relationship with the third-party service.

In making the selection between the first- and third-party vehicles 110a and 110b, respectively, the operator management component 240 may compare costs between selecting the first-party vehicle 110a as opposed to the third-party vehicle 110b. For example, the operator management component 240 may determine a cost for assigning the user request to the first-party vehicle 110a, including any overtime or additional costs associate for exceeding a contractual limit, fuel costs, vehicle wear and tear, and so forth, as described above, at least in part. In some embodiments, the operator management component evaluates restrictions in the contractual relationship between the delivery system 100 and the third-party service, such as those regarding items that can be delivered by the third-party service, those regarding cost, or those regarding locations through or to which the third-party vehicles 110b can travel.

In some embodiments, the operator management component 240 monitors ratings or services provided by particular vehicles 110 and/or operators of the vehicles 110 and selects the vehicle 110 based on the ratings or services provided by the vehicles 110. The ratings or services may be stored in the operator database 241. For example, the operator management component 240 determines that, based on the ratings or the services available, the vehicle 110a is unable to transport items that are temperature sensitive or that the vehicle 110b is often late in arriving at its destinations. Accordingly, the operator management component 240 may work with the request servicing component to ensure that the first-party vehicle 110a is not selected for transport of items that are temperature sensitive, for example, items that need to be refrigerated or heated during transport, and/or that the third-party vehicle 110b is not selected for transport of items that are time critical.

In some embodiments, the vehicles 110 identified by the vehicle location management component 220 comprise first-party vehicles 110a affiliated with the delivery system 100 and/or third-party vehicles 110b belonging to the third-party transportation and/or delivery services. The first-party vehicles 110a affiliated with the delivery system 100 may be assigned to or selected for completion of any received user request without requesting any confirmation from the operator of the first-party vehicles 110a. For example, the first-party vehicles 110a may be commandeered by the delivery system 100 without input from the vehicles 110 or operators. In some embodiments, the first-party vehicles 110a affiliated with the delivery system 100 require acceptance from the operator of the first-party vehicles 110a before any of the first-party vehicles 110a are assigned or selected for completion of the received user request. However, any third-party vehicles 110b not affiliated with the delivery system 100 may require acceptance from the operator of the third-party vehicles 110b before any of the third-party vehicles 110b are assigned or selected for completion of any received user request. In some embodiments, the third-party vehicles 110b are assigned to or selected for completion of any received user request without requesting any confirmation from the operator of the third-party vehicles 110b, for example if the user request is a high priority request or if no first-party vehicles 110a are available to assist. In some embodiments, if a third-party vehicle 110b is required to accept the request, the delivery system 100 may increase compensation or benefits provided to the third-party vehicle 110b.

Upon selecting the vehicle 110 to fulfill the received user request, and receiving confirmation from the operator, as appropriate, the request servicing component 205 may update the selected vehicle's route to include the pickup and delivery of the item identified in the user's request. To accomplish this, the request servicing component 205 may communicate with the vehicle route control component 230. In some embodiments, the vehicle route control component 230 is in communication with a vehicle routing system (not shown in this figure) that coordinates and monitors routes for each of the vehicles 110. For example, the vehicle routing system may comprise a centralized route monitoring system for the vehicle 110, such as when the vehicle 110 is a first-party vehicle that may have its route centrally controlled and/or monitored. In some embodiments, the vehicle routing system may comprise a navigation system of the vehicle 110, such as when the vehicle 110 is a third-party vehicle that may not have its route centrally controlled and/or monitored.

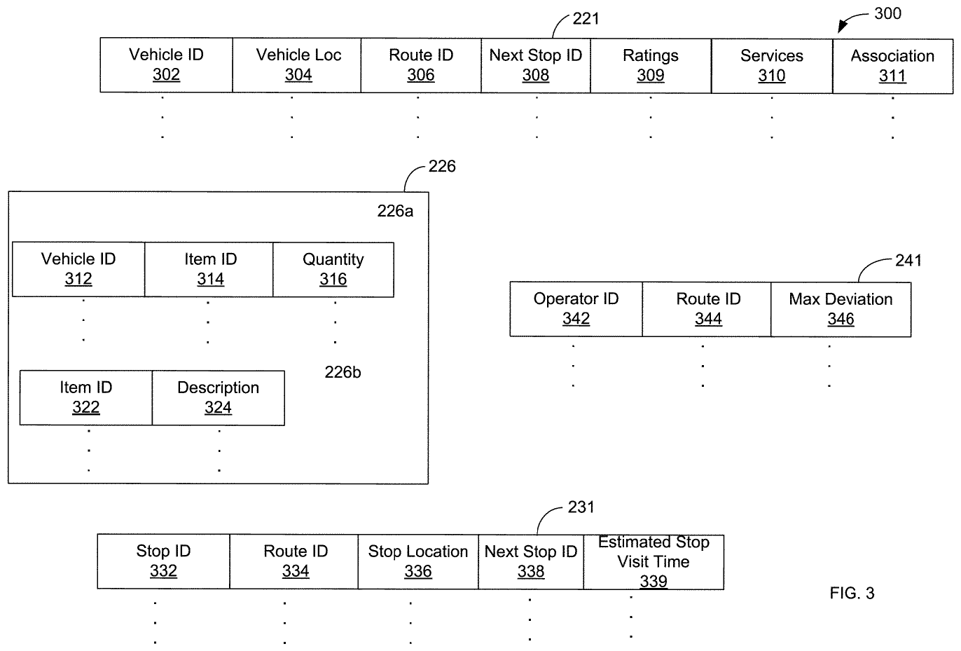

FIG. 3 shows exemplary table structures for relational databases of FIG. 2. The vehicle database 221 may include a vehicle identification 302, vehicle location 304, route identification 306, next stop identification 308, ratings 309, services 310, and association 311. The vehicle identification may serve to uniquely identify a vehicle 110 within the delivery system 100. The vehicle location column 304 may indicate a most recently reported location of the vehicle 110 identified by the vehicle ID column 302. The vehicle location column 304 may be set by the vehicle location management component 220 upon receiving a location update from a vehicle 110, such as any of vehicles 110a-b.

The route identification field 306 may identify a delivery route assigned to the vehicle 110 identified via the vehicle ID field 302. The next stop identification field 308 may indicate a next stop for the vehicle 110 identified by the vehicle identification field 302 along the route identified by the route ID field 306. The ratings field 309 may identify a rating assigned to the vehicle 110 identified via the vehicle ID field 302. In some embodiments, the ratings are provided by users that previously used that vehicle 110, and/or the operator of the vehicle 110, to transport an item or themselves. The rating may be dynamic and controlled via the operator management component 240. The services field 310 may identify the services available for the vehicle 110, thereby identifying which vehicles 110 are able to deliver particular items that have specific requirements. The association field 311 may identify the whether the vehicle is associated with a first-party service or a third-party service, thereby identifying which vehicles 110 belong to which delivery service.

The vehicle inventory database 226 includes a table 226a having a vehicle ID column 312, item ID column 314, and a quantity column 316. In some embodiments, though not shown in these figures, the table 226a may also include a capacity field 318. In some embodiments, the capacity field 318 may dynamically indicate a remaining capacity of the vehicle 110, in view of the items that the vehicle 110 is currently transporting. In some embodiments, the capacity field 318 may be provided in cubic feet or in a number of items for which the vehicle 110 still has room in view of its current inventory. As used herein, the term “current” relates to the time at which a corresponding measurement or value is determined or measured. The item ID column 314 identifies an inventory item record in the inventory item table discussed below.

The inventory item table 226b includes an item ID column 322 and a description column 324. In some embodiments, the inventory item table 226b may also include a critical time associated with the item, if one exists. The description column 324 includes a text description of the inventory item identified by the item id column 322.

The route database 231 includes a stop identification column 332, route identification column 334, stop location column 336, a next stop identification column 338, and an estimated time column 339. The stop identification column 332 provides a unique identifier for a stop on the route identified by the route identification column 334, within the delivery system 100. The stop location column 336 identifies a geographic location of the stop identified by the stop identification column 332. The geographic location can be stored in the stop location column 336 as an address, or as location coordinates, such as GPS coordinates. The next stop identification column 338 identifies a stop that is scheduled after the stop identified by the stop identification column 332, along the route identified in the route identification column 336. The estimated time column 339 includes the estimated time a delivery resource, such as vehicle 110a-b, will be at the next stop.

The operator database 241 includes an operator ID column 342, a route ID column 344, and a max deviation column 346. The operator ID column 342 contains a unique identifier for an operator of the vehicle. The route ID column 344 identifies a route in the route database 231 assigned to the operator identified by column 342. The maximum deviation column 346 indicates a maximum deviation from the route (identified by route ID 344) allowed for the operator (identified by operator id 342).

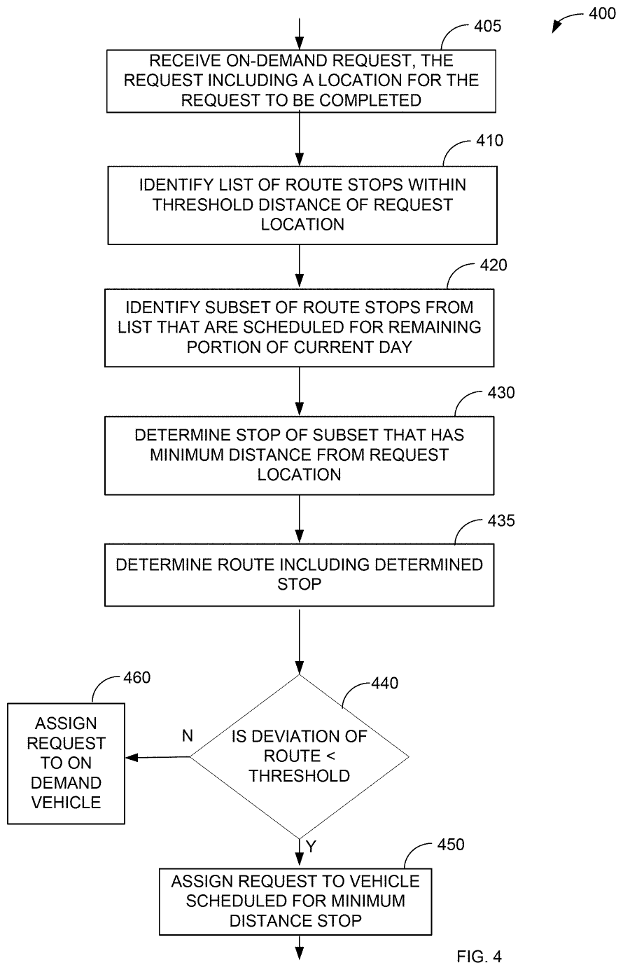

FIG. 4 is a flowchart of an exemplary method 400 for satisfying a localized transportation request within the delivery system 100. In some aspects, the method 400 discussed below with respect to FIG. 4 is performed by the request servicing component 205 discussed above with respect to FIG. 2. For example, in some aspects, the request servicing component 205 may include data defining instructions for an electronic hardware processor. The electronic hardware processor may execute the instructions, which configure the processor to perform the functions of method 400 discussed below. In some aspects, any other component of the delivery system 100 performs the method 400.

In block 405, a request is received at the request servicing component 205. For example, as discussed above, a customer 140 may initiate a request to the delivery system 100. The request may indicate a geographic location at which the request will be completed. The request may request a package be picked-up at a location, such as a home or business address associated with the customer 140. Alternatively or in addition, the request may be for delivery of a package or an item. For example, in some aspects, the delivery system 100 may provide for on-demand shopping. A customer 140 may select a particular item they desire to purchase and submit a request to the delivery system 100 indicating the same. In some other aspects, the delivery system 100 may provide for on-demand delivery of packages shipped directly to the customer. By requesting the delivery on-demand, the customer 140 may avoid packages being dropped off at their associated location when they are not prepared to receive the delivery.

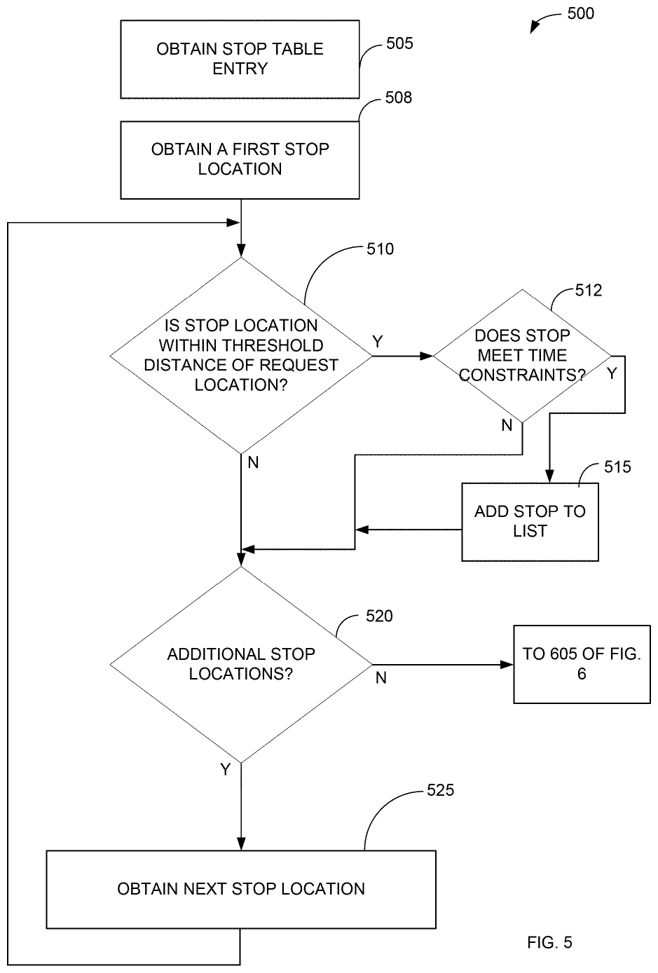

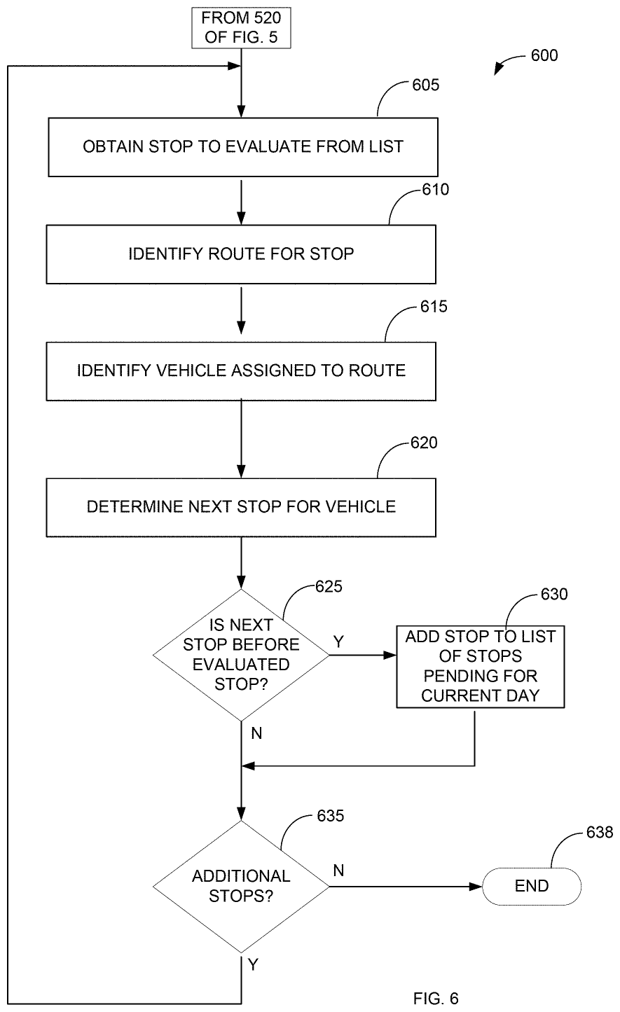

In block 410, a list of route stops is identified that is within a threshold distance of the location for the request to be completed. In some aspects, block 410 may be performed as described below with respect to FIG. 5.

In block 420, a subset of route stops from the list identified in block 410 is identified. The subset includes route stops that are still pending for the current day. In other words, block 420 identifies stops that a vehicle 110 is yet to deliver to. Stops that have already been completed may not be particularly relevant to scheduling an on-demand transaction, since the vehicle 110 may have already departed the location of the completed stop and may no longer be in a proximity of that location for the remainder of the day.

In block 430, a stop with a minimum distance from the location for the request to be completed is identified. In some aspects, block 430 may compare stop location column 336 of the route database 231 for stops within the subset to identify the stop with the minimum distance.

In block 435, a route associated with the stop is identified. In some aspects, block 440 may include determining a record in the database 231 with a stop identification column 332 equivalent to the stop identification for the stop with the minimum distance determined in block 430.

Block 440 determines if a deviation from the route associated with the minimum distance is greater than a threshold. In some aspects, the threshold may be based on the identity of an operator performing the route. For example, block 440 may involve a search of the operator database 241 for an entry having a route identification column 344 that matches the route identification of the route determined in block 435. The entry, as shown in FIG. 3, may also include an operator ID in column 342 of an operator who is operating a vehicle on the determined route. A maximum deviation for the operator with the ID in column 342 may be provided by column 346. The deviation provided by column 346 may be the threshold of decision block 440 in some aspects. If the deviation from the route of block 435 is less than a threshold, for example, the deviation provided by column 346 in some aspects, then the method 400 moves to block 450, which assigns the request to the vehicle 110 scheduled for the minimum distance stop which was determined in block 430, such as the first-party vehicle 110a. If the deviation from the route of block 435 is greater than the threshold, then the method 400 moves to block 460, which assigns the request to an on demand vehicle, such as the third-party vehicle 110b.

At block 450, where the request is assigned to the vehicle 110 scheduled for the minimum distance stop, the appropriate vehicle 110 may be identified based on information from the vehicle database 221. In some embodiments, the appropriate vehicle 110 is identified prior to the request being assigned to the vehicle 110 scheduled for the minimum distance stop, such as at one or more of blocks 420, 430, and/or 435. For example, the route determined in block 435 is utilized to search the vehicle database 221 for a row with a route ID column 306 matching the determined route. The vehicle ID field 302 of the identified row may indicate the vehicle 110 to be assigned the request. The vehicle 110 identified in the vehicle ID field 302 may be assigned the request.

In some aspects, assigning the request to one of vehicles 110a-b includes transmitting an electronic command, for example, via a network message utilizing TCP/IP or other networking protocol, to the assigned first-party vehicle 110a, indicating the assignment. In some aspects, the vehicle 110a or 110b may execute the request autonomously. For example, in embodiments utilizing autonomous delivery vehicles, assigning the request to the vehicle may control the vehicle to perform the request, such as delivering an inventory item to an address associated with the request, or picking up a package from the address, without human intervention.

At block 460, assigning the request to the on demand vehicle 110 may comprise identifying a third-party vehicle 110b, communicating the request to the third-party vehicle 110b, and receiving a response that the third-party vehicle 110b accepts the request. In some embodiments, the on demand vehicle 110 is a first-party vehicle 110a that is not selected based on route deviation for the pickup, but rather selected based on one or more other factors.

While blocks 410-435 may use route stops as one aspect of assigning a request to the vehicle 110, other embodiments are contemplated. For example, in some aspects, the method 400 for satisfying a received request includes the vehicle database 221 searching for the vehicle 110 closest to the location specified in the request. The search may be based on the vehicle location field 304. In some aspects, the method 400 for satisfying a received request includes identifying vehicles 110 within a predetermined range of the location specified in the request or a destination specified in the request. From the identified vehicles, stops remaining for a particular day may be identified, based on the route id field 306 and the route database 231. The vehicle 110 to be assigned to the request may then be determined as the vehicle 110 having a remaining stop closest to the on-demand location. The vehicle 110 may also be assigned based on costs of the first- and third-party vehicles 110a and 110b, restrictions on one or more of the first- and third-party vehicles 110a and 110b, and so forth, as described above.

In some embodiments, the method 400 for satisfying a received request includes evaluating conditions requested in the user request, which includes restrictions against using one of the first- or third-party vehicles 110a and 110b, respectively. In some embodiments, the user request is distributed only after considering additional restrictions relating the vehicles 110 themselves, such as contract restrictions that limit types or quantities of goods, times or areas of operation, minimum/maximum costs of transporting with one of the first- or third-party vehicles 110a and 110b, respectively. For example, the user request may restrict use of the third-party vehicle 110b for high value items being transported or for personal documents such as passports, etc. Alternatively, or additionally, if the cost of using the third-party vehicle 110b exceeds a threshold amount and the user request is not urgent or can wait until a first-party vehicle 110a is available, the user request may be assigned to the first-party vehicle 110a for later delivery based on the costs of using the third-party vehicle.

In some embodiments, costs for using the third-party vehicle 110b are received from the third-party vehicle 110b or from a system associated with the third-party vehicle 110b. The delivery system 100 may obtain costs for using the third-party vehicle 110b prior to assigning the user request and may, accordingly, use the cost in making the selection between the first- and third-party vehicles 110a and 110b, as described herein. In some embodiments, the delivery system obtains costs for use of the third-party vehicle 110b only after sending the request for acceptance by the third-party vehicle 110b.

FIG. 5 is a flowchart of an exemplary method of identifying stops that fall within criteria for delivery or pickup of an object using the localized delivery system. In some aspects, a request is for delivery of an item or package to a location. In some aspects, the request is for pick-up of a package at the location. In some aspects, the process 500 discussed below with respect to FIG. 5 is performed by an electronic hardware processor. For example, in some aspects, instructions contained within one or more of the request servicing component 205 and/or the vehicle route control component 230 configure the electronic hardware processor to perform the process 500. In some aspects, process 500 described below may be one way of implementing block 410, discussed above with respect to method 400 and FIG. 4.

In block 505, a stop table is obtained. In some aspects, the stop table may be obtained from the route table 231, discussed above with respect to FIG. 3. In some embodiments, after obtaining the stop table, the process 500 move to block 508, where a first stop is obtained from the stop table. Next, in block 510, the process examines the selected stop to determine if the stop is within a threshold distance of the location associated with the request, as described with respect to decision block 510. If the stop location is not within the threshold distance, the process 500 proceeds to block 520 and functions as described hereinafter. If the stop location is within the threshold distance, process 500 moves from decision block 510 to decision block 512, which evaluates whether the stop meets time constraints. Time constraints may be based on a deadline to complete the request, and a time at which the vehicle 110 may visit the stop location. In some aspects, the time may be stored in the estimated stop visit time field 339 of the route database 231. In some aspects, block 512 may utilize a metric to determine an amount of time required for the vehicle 110 to get from the stop to a location indicated by the request. The metric may be based on the geographic region of the stop. For example, stops located in more metropolitan areas may use more time for a given geographic distance than stops located in more rural areas. The metric may be used, in combination with a distance between the stop's location and the location associated with the request to determine whether the stop can be utilized to plan servicing of the request. If the stop does not meet the time constraints, process 500 moves from block 512 to block 520. Otherwise, process 500 moves from block 512 to block 515, which adds the stop to a list. From block 515, the process 500 moves to block 520.

Decision block 520 evaluates whether there are additional stop locations that have not yet been evaluated. If there are, the process 500 moves to block 525, which obtains a next stop for evaluation. From block 525, the process returns to block 510 and continues as described above. Otherwise, in block 520, if there are no other stop locations to evaluate, processing moves to block 605 of FIG. 6 and proceeds as described below. The list described above with respect to block 515 may be equivalent to the list of block 410 of FIG. 4.

FIG. 6 is a flowchart for an exemplary method of identifying a subset of stops scheduled for a remaining portion of a day. In some aspects, process 600 may be one way to implement block 420, discussed above with respect to FIG. 4. In some aspects, process 600 may be implemented by an electronic hardware processor. For example, instructions stored in the request servicing component 205 may configure an electronic hardware processor to perform one or more of the functions discussed below with respect to process 600.

In block 605, a stop is obtained from a list, such as the stop list from block 515 of FIG. 5. In some aspects, the list is a list of stops, with each stop having an associated location, and an associated route of which the stop is a part. For example, the list may be the list referenced in blocks 410 and 420 of process 400. For example, block 410 may identify a list of route stops, and block 605 may obtain a stop from this list. In some aspects, the stop obtained in block 605 may be a stop identified by the route database 231, discussed above with respect to at least FIGS. 2 and 3. For example, in some aspects, block 605 may include reading the exemplary database 231 to obtain one row. In one exemplary aspect, the row may include a stop identification 332, route ID 334, stop location 336, and next stop identification 338.

In block 610, a route for the stop is identified. In some aspects, the route is identified via route ID 334 in the row retrieved from the exemplary database 231 or its equivalent in block 605.

In block 615, a vehicle 110 assigned to the route is identified. In some aspects, identifying the vehicle 110 may include searching the vehicle database 221 for the route identified in block 610. The row including the route ID column 306 that matches the route determined in block 610 may include the vehicle identifier for the vehicle 110 in the vehicle ID column 302.

In block 620, a next stop for the vehicle 110 is identified. In other words, the vehicle 110 determined in block 615 may be currently performing its planned route. The vehicle 110 may be performing stops, including picking up packages or delivering inventory items or packages as necessary. Thus, it may be necessary to determine whether the vehicle 110 has yet to perform the stop of block 605. If the vehicle 110 has already performed the stop, the vehicle 110 may not be a good choice for performing a request, at least based on the inclusion of the stop of block 605 on its route (determined in block 610).

Block 625 determines whether the next stop determined in block 620 is a stop that occurs along the vehicle's route before the evaluated stop of block 605. In some aspects, this may be determined by traversing the route database 231, starting at the vehicle's next stop 308 of the vehicle database 221. For example, after identifying a row in the route database 231 for the next stop of the vehicle 110 identified by the column 308 of the database 221, a second next stop may be identified via the next stop ID 338 may be identified from the route database 231. The row for the second next stop may then be found in the route database 231 to identify a third next stop. This process may continue until the stop of block 605 is found in the route, or an end of the route is reached (for example, a predetermined value for the next stop ID column 338 may signify the end of a route in some aspects). If the stop is found, then process 600 moves from block 625 to block 630, and the stop obtained in block 605 is added to a list of stops pending for the current day. In some aspects, the list referenced in block 630 may identify the subset of route stops scheduled for the remaining portion of the current day, described above with respect to block 420 of process 400.

From block 625, if it is found that the next stop is before the evaluated stop, or from block 630, the process moves to decision block 635. In block 635, the process 600 determines whether there are additional stops to be evaluated. If there are additional stops, the process 600 moves from block 635 to block 605 and continues as described above. If block 635 determines there are no additional stops, the process moves to block 638 and ends.

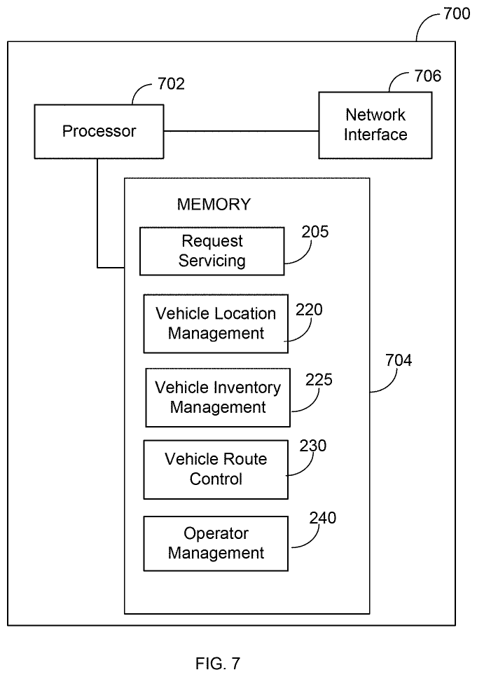

The device 700 of FIG. 7 is a block diagram of an exemplary device for performing one or more of the methods described herein. While the block diagram of FIG. 7 illustrates a single device 700, in some aspects, one of skill in the art would recognize that the embodiments described herein may be performed by a combination of two or more devices. For example, embodiments utilizing a cloud-based infrastructure for execution of the described processes and methods is contemplated.

The device 700 includes an electronic hardware processor 702, electronic hardware memory 704, and a network interface 706. The memory 704 may store instructions that configure the processor 702 to perform one or more of the functions described herein. For example, the memory may store the request servicing component 205, vehicle location management component 220, vehicle inventory management 225, vehicle route control component 230, and/or operator management component 240, discussed above with respect to FIG. 2. While FIG. 7 suggests one exemplary organization for instructions that may configure the processor 702, one of skill in the art would understand that the organization suggested by FIG. 7 is only exemplary, and other embodiments may organize the instructions that configure the processor 702 to perform one or more of the functions described herein in a myriad of different ways. For example, in some aspects, the components described above may be stored in a plurality of different hardware memories. In some aspects, the components described above may be distributed across two or more physical devices, each physical device including one or more hardware processors. In some aspects, the disclosed methods and systems may be implemented using a cloud infrastructure. In some such infrastructures, applications may be dynamically moved on-demand within a pool of computing devices, each having one or more processors. At any one-time, various portions of the components discussed above may be running in any number of cloud computing configurations.

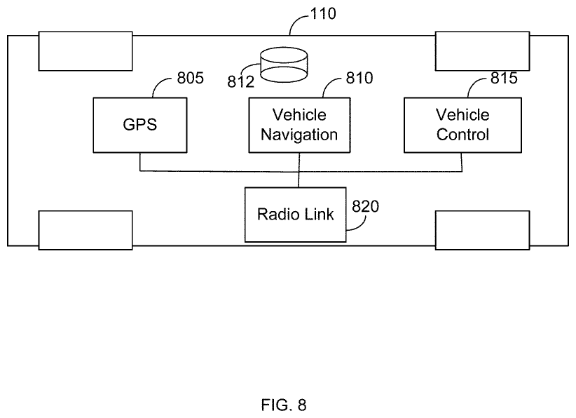

FIG. 8 is a block diagram of an exemplary delivery vehicle. The delivery vehicle 110 shown in FIG. 8 may be an exemplary embodiment of the delivery vehicles 110a-b shown in FIG. 1. The exemplary delivery vehicle 110 includes a global positioning system (GPS) receiver 805, vehicle navigation component 810, vehicle route database 812, a vehicle control component 815, and a radio link 820. The radio link 820 may enable one or more of the GPS receiver 805, vehicle navigation component 810, or vehicle control component 815 to communicate wirelessly with other components of the disclosed methods and systems, such as any of the components shown in FIG. 2.

The GPS receiver 805 may receive GPS signals from GPS satellites to determine a position of the vehicle 110. This information may be reported, via the radio link provided via radio link component 820, to for example, the vehicle location management component 220 in some aspects. This may enable the disclosed methods and systems to maintain a current record of a location of the vehicle 110, and of multiple delivery vehicles, such as the vehicles 110a-b of FIG. 1, such that an appropriate vehicle can be selected to perform an on-demand transaction based, in part, on the vehicle's respective location.

The vehicle navigation component 810 may control navigation of the vehicle 110 along a route. Route information may be retrieved from the route database 812. In some aspects, the vehicle navigation component 810 may receive route updates via the radio link 820, from, for example, the vehicle route control component 230, illustrated with respect to FIG. 2. The vehicle navigation component 810 may provide instructions to the vehicle control component 815. For example, the vehicle navigation component 810 may send commands such as a command to turn the vehicle 110 to a particular heading, stop the vehicle 110, or drive the vehicle 110 at a particular speed to the vehicle control component 815.

The vehicle control component 815 may provide autonomous, electronic control of the vehicle 110 in some aspects. As discussed above, the vehicle control component 815 may receive commands such as a command to turn to a particular heading, stop, or drive at a particular speed from the vehicle navigation component 810. The vehicle control component 815 may maintain electronic interfaces with vehicle systems, such as braking systems, engine systems, and steering systems (not shown in FIG. 8) that can affect the commands received from the vehicle navigation component 810. In aspects of the vehicle 110 that may be manually controlled by a human operator, the vehicle control component 815 may function to display instructions to the human operator to effect particular routes. For example, upon receiving a command to move the vehicle to a particular address, the vehicle control component may display the address on a display screen of the vehicle, such that the human operator can read the display screen and drive the vehicle to the address. In some aspects, the human operator may be assisted by a navigation application that provides route information to the commanded address.

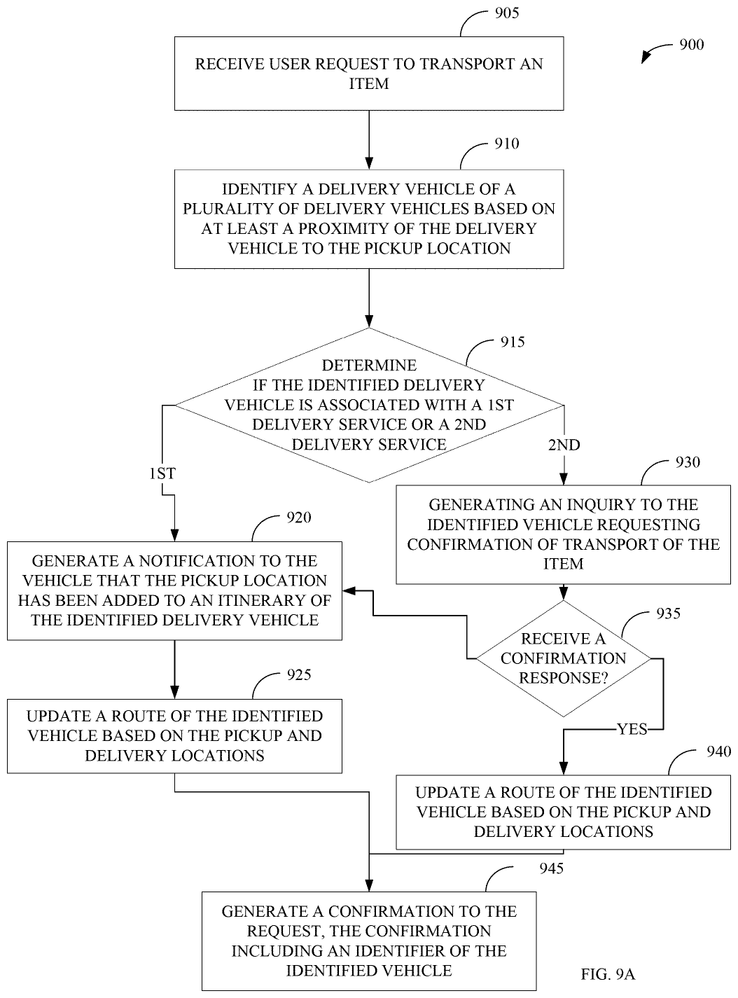

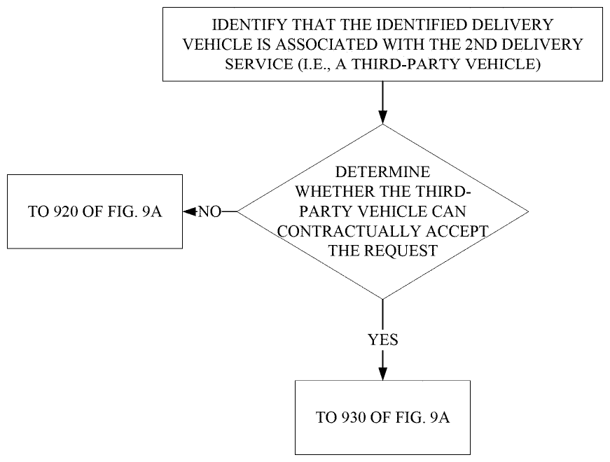

FIG. 9A is a flowchart of an exemplary method for processing a localized transportation request. In some aspects, the process 900 discussed below with respect to FIG. 9A may be performed by one or more of the components discussed above with respect to FIG. 2 or FIG. 7.

In block 905, a user request to transport an item is received. The request may include at least one pickup location and delivery location. In some embodiments, the request may further include details of the item to be transported as well as details regarding timing of transport (for example, pickup time and/or delivery time) and restrictions on the transportation (for example, requirements for transportation time constraints or temperature requirements, etc.). The user request may take one of at least three forms. The user request may be a request to pick up the item at a pickup location and deliver it to the user at a delivery location. Alternatively, the user request may be a request to pick up the item from the user at the pickup location and deliver the item to the delivery location. Alternatively, the user request may be a request to pick up the item from the pickup location and deliver the item to the item to the delivery location where the user is not at either of the pickup or delivery locations. The delivery may be for an item that is previously addressed to the delivery location. For example, the user at the delivery location may have previously requested delivery of the item to the delivery location, and the user request is requesting that the previously requested item be delivered within a particular time-frame. Alternatively, the user request may be a first request for the item. In some aspects, the user request may be for an item that may be included in one or more vehicle inventories. For example, frequently ordered items may be stocked on-board delivery vehicles to facilitate quick delivery for these items. Thus, in some aspects, the user request may identify one or more items for delivery. The items may be identified in some aspects, by specifying the item ID 314 value for the item in the request.

In block 910, a delivery vehicle for the item is identified from a plurality of delivery vehicles in a region in which the item is to be delivered. In some embodiments, the delivery vehicle may correspond to one of vehicles 110a-b. In some embodiments, the delivery vehicle may be identified or selected based on its proximity to one or both of the pickup location and the delivery location. In some embodiments, the delivery vehicle may be identified or selected based on one or more other factors, including transport capabilities of the vehicle, existing route of the vehicle, traffic conditions, remaining route or schedule of the vehicle, ratings, driver management system (DMS) metrics for the vehicle, and so forth. In some embodiments, a current location of each of plurality of vehicles on a plurality of delivery routes is determined. For example, in some aspects, the vehicle information table 221 may be searched to identify vehicle locations 304. In some embodiments, the vehicle information table 221 may also be searched to identify vehicle ratings and services. In some aspects, the DMS metrics may be obtained from an external source or a DMS server.

In block 915, a determination is made as to whether the identified delivery vehicle belongs or is associated with a first delivery service or a second delivery service. In some embodiments, the first delivery service may correspond to a first-party service (or the delivery system 100 of FIG. 1) and a second delivery service may correspond to a third-party for example, the third-party transportation and/or delivery services described above. In some embodiments, the association of the vehicle with the first delivery service or the second delivery service may be part of the vehicle ID 302. In some embodiments, the association with the first and/or second delivery service may be identified or conveyed in the route ID 306 or the association ID 311.

If it is determined in block 915 that the identified delivery vehicle is associated with a first delivery service the process 900 moves to block 920.

In block 920, a notification to the vehicle is generated. The notification indicates to the vehicle (and its operator) that the item pickup location has been added to an itinerary (or route) of the identified delivery vehicle. In some embodiments, if details regarding the item delivery are available (for example, details of timing constraints, item handling, and so forth), these details may be provided to the operator and the vehicle. The notification to the vehicle is generated in response to determining that the vehicle is associated with the first delivery service (e.g., is a first-party vehicle). In some embodiments, since the first-party vehicles are associated with the delivery system 100, the first-party vehicles may not have an option to decline transporting the item per the user request.

In block 925, the itinerary and/or route of the vehicle is updated with the new pickup location and delivery location, as well as with details of the item as needed for route maintenance. Once the itinerary and/or route is updated, the process 900 proceeds to block 945.

In block 945, a confirmation is generated in response to the request from the user. The confirmation may include an identifier of the identified vehicle (for example, the vehicle ID 302) and any other details that may be relevant to the user. For example, the confirmation may also include the rating associated with the vehicle and/or operator. The confirmation may be transmitted to the user via the same communication method by which the request was received.

If, in block, 915, it is determined that the identified delivery vehicle is associated with a second delivery service, the process 900 proceeds to block 930.

In block 930, an inquiry to the identified vehicle is generated. The inquiry requests that the identified third-party vehicle 110b confirm or accept the request to transport the item. The inquiry may be sent the third-party vehicle 110b because the identified vehicle is associated with the second delivery service (for example, the third-party service). When the identified vehicle is a third-party vehicle 110b, the vehicle and/or its operator may have the option to accept or reject transportation of the item. The accepting or rejecting may be based on the vehicle being subject to rules, requirements, and/or conditions outside of the control of, and potentially unknown to, the delivery system 100. For example, since the vehicle associated with the third-party service may be paid per trip it makes, the vehicle (and its owner) determines whether to reject the request to transport the item in view of whether or not the vehicle will lose other transportation opportunities due to the item transportation.

In some embodiments, whether or not the third-party vehicle 110b is an option for a particular user request may depend on various factors. For example, costs for using the third-party vehicle 110b, proximity to route details of the user request, and ratings, services, and available space in the vehicle 110b may be considered in determining or selecting the third-party vehicle 110b. Additionally, or alternatively, before generating the inquiry at block 930, the component of the delivery system 100 may confirm that the user request does not violate any contractual terms with the third-party vehicle 110b. The contractual terms may include cost of using the third-party vehicle 110b, time of day, location of travel, duration of expected use, required approval, items restrictions, and so forth. For example, before generating the inquiry, the delivery system 100 confirms that the item being transported is not restricted by a third-party contract or that transport of the item will not take the third-party vehicle 110b into a restricted area or beyond a restricted duration of use. Accordingly, the delivery system 100 may ensure that selection of the third-party vehicle 110b does not violate the user request and does not violate any contracts established with the third-party vehicle and/or the third-party service. Additionally, the delivery system 100 may consider whether the third-party vehicle 110b is subject to rules, requirements, and/or conditions outside of the control of the delivery system 100 when generating the inquiry at block 930. The delivery system 100 may option for the less efficient use of the first-party vehicle 110a based the third-party vehicle 110b being restricted from transporting the item or good based on one or more of the rules, requirements, and/or conditions. An exemplary method for determining whether the third-party vehicle 110b can be selected to transport according to the user request is shown in FIG. 9B. For example, since the vehicle associated with the third-party service may be paid per trip it makes, the vehicle (and its owner) determines whether to reject the request to transport the item in view of whether or not the vehicle will lose other transportation opportunities due to the item transportation.

In block 935, the process 900 determines whether a confirmation response is received from the identified vehicle in response to the generated inquiry. If the process 900 does receive a confirmation response, the process 900 proceeds to block 940. If the process 900 does not receive a confirmation response, then the process 900 proceeds to block 920, where first-party vehicle 110a is notified regarding the user request and added pickup location, as described above. In some embodiments, the confirmation response may be received indicating that the identified vehicle will transport the item per the user request.

In block 940, a route of the identified vehicle is updated based on the pickup and delivery locations for the item.

After block 940, the confirmation to the user request is generated and transmitted to the user including the identification information for the identified vehicle (for example, at block 945).

From block 940, the process 900 moves to block 945 and proceeds as described above.

FIG. 9B is a flowchart of an exemplary process 950 for determining whether the third-party vehicle 110b can be selected by the delivery system 100. In some aspects, the process 950 discussed below with respect to FIG. 9B may be performed by one or more of the components discussed above with respect to FIG. 2 or FIG. 7. In some embodiments, the process 950 may be performed after block 915 of process 900 and allow the delivery system 900 to determine whether one or more constraints prevent use of the third-party vehicle 110b for the user request.

At block 955, the process 950 may identify the determination from block 915 that the identified delivery vehicle is associated with the second delivery service (for example, from block 915. Based on this determination, the process 900 may determine, at block 960, whether the third-party vehicle 110b can be selected for the user request. For example, at block 960, the process 900 determines whether the third-party vehicle 110b is restricted from accepting the user request based on one or more contractual terms, such as the area of travel required to complete the user request or such as a time or duration of operation required to complete the user request. If the third-party vehicle 110b is restricted from accepting the user request due to one or more contract terms, then the process 950 proceeds to block 920 of FIG. 9A, where the first-party vehicle is notified regarding the user request and added pickup location, as described above. If the third-party vehicle 110b is not restricted from accepting the user request due to one or more contract terms, then the process 950 proceeds to block 930 of FIG. 9A, where the inquiry to the third-party vehicle is generated for confirmation of transport of the item. Accordingly, by the process 950, the delivery system 100 may consider whether the third-party vehicle 110b is subject to rules, requirements, and/or conditions outside of the control of the delivery system 100 and determine to select the less efficient use of the first-party vehicle 110a based the third-party vehicle 110b being restricted from transporting the item or good based on one or more of the rules, requirements, and/or conditions.

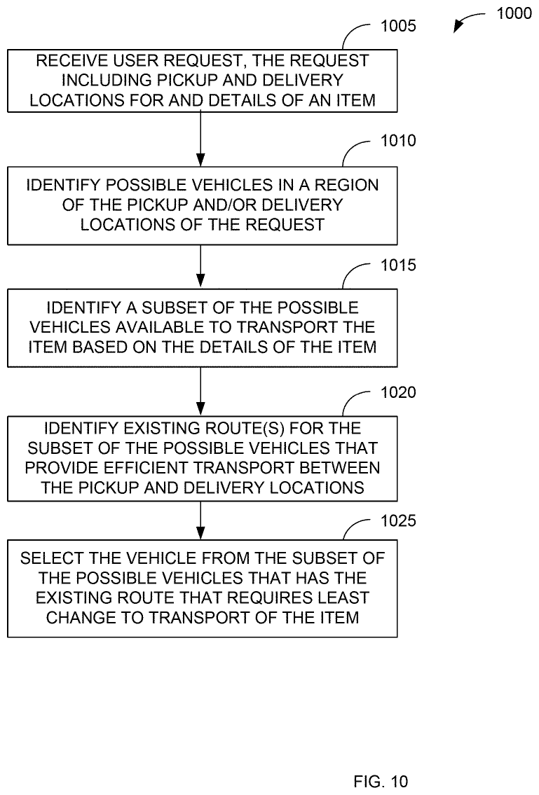

FIG. 10 is a flowchart of an exemplary method 1000 for selecting a vehicle 110 to perform item transportation according to the localized transportation request. In some aspects, the method 1000 discussed below with respect to FIG. 10 may be performed by one or more of the components discussed above with respect to FIG. 2 or FIG. 7.

At block 1005, the user request is received from the user via a communication path. In some embodiments, the user request may include pickup and delivery locations as well as details of the item (for example, timing constraints, temperature constraints, and so forth). In some embodiments, the timing constraints may include details regarding when the item can be picked up and/or when it can be delivered. In some embodiments, the timing constraints may include details regarding when the item must be picked up by and/or when it must be delivered by. In some embodiments, the timing constraints may include a maximum duration for which the item can be transported. In some embodiments, the user request may include limitations on ratings for the vehicle, such that vehicles with a rating below that requested by the user cannot be identified or selected for transportation of the item per the user request. In some embodiments, the limitations on ratings for the vehicles may include identifying a rating below a threshold established by the transporter or defined by others such as government standards or regulations, etc. In some embodiments, the user request may include limitations on methods or modes of delivery. For example, in some embodiments, the user restricts the transport of the item via motorcycle, bicycle, or drone, instead requesting that the item only be transported within an enclosed vehicle.

In some embodiments, details of the item being transported may control for automatic selection or restriction of transportation methods or modes. For example, drones may not be used for transport of any medication, battery power devices, or potentially dangerous items. Receipt of the user request may be via the computer portal 210 (for example, via an app or website), which interacts with the request servicing component 205. In some embodiments, the request servicing component 205 may receive the user request and identify relevant information in the user request (for example, the location information, item details, timing information, and so forth).

At block 1010, possible vehicles within a region of the pickup and/or delivery locations may be identified as potentially being requested to transport the item per the received request. In some embodiments, this identification may be made based purely on the location of the vehicles in the region at the time the user request is received or based on the time at which the transportation is requested, if requested at a time other than the present. In some embodiments, the position of each of the vehicles in the region of the pickup and/or delivery locations may be determined based on GPS or other information received from each of the vehicles, as noted above in relation to FIG. 2 and the vehicle location management component 220. Thus, identification of the possible vehicles in the region may involve interaction between the requesting services component 205 and the vehicle location management component 220.

In some embodiments, identifying the possible vehicles may include identifying vehicles that are first-party vehicles and associated with and/or able to be commandeered by the delivery system 100 and identifying vehicles that are third-party vehicles and not necessarily associated with and cannot be commandeered by the delivery system 100. In some embodiments, the identification may be made based on vehicles being within a specified distance or time from one or both of the pickup and/or delivery locations or any point along a shortest distance or time route between the pickup and delivery locations. For example, vehicles within one mile or three minutes of either the pickup and/or delivery locations or any point along a shorted route between the two may be identified.

In some embodiments, this distance or time may be threshold. In some embodiments, this threshold may be established by the delivery system 100 and may be adjustable based on a quantity of vehicles identified. For example, the request servicing component 205 or the vehicle location management component 220 may establish the threshold such that at least a minimum number of vehicles is returned, where the minimum number of vehicles is also adjustable. In some embodiments, 10 vehicles may be identified as possible vehicles being in the region of the pickup and/or delivery locations.

At block 1015, a subset of the identified possible vehicles that are available to transport the item based on the details of the item is identified. For example, if 10 vehicles are identified as being in the region of the pickup and/or delivery locations, a subset of vehicles of those 10 vehicles may be identified as being available to handle the specifics of the item per the user request. For example, some of the possible vehicles may be excluded based on having full inventories or based on not being able to meet particular timing constraints or other item specific constraints. For example, if one or more of the 10 vehicles is a drone, the drone may be excluded from the subset based on the item being a medication or a potentially dangerous item that cannot be transported via the drone. In some embodiments, if one or more of the 10 vehicles is not temperature controlled or does not have the ability to control a temperature of the item, that vehicle may be excluded from the subset. Alternatively, or additionally, vehicle ratings or other services available from the vehicle may be used to exclude vehicles from the subset. In some embodiments, the details of the item or the user requested information may be prioritized such that certain aspects of the request take priority over others. For example, in some embodiments, the time of delivery may be more important that pickup time, transit time, or transport mode. The delivery system 100 may be able to coordinate transportation accounting for such prioritization.

At block 1020, one or more existing routes form the subset of possible vehicles is identified. The one or more existing routes are identified based on being able to provide efficient transportation between the pickup and/or delivery locations. In some embodiments, the one or more existing routes may be identified by the vehicle route control component 230. In some embodiments, the one or more existing routes may be identified by the request servicing component 205 in communication with the vehicle route control component 230. For example, identified existing routes may include those that have would require changes within a threshold amount to accommodate the transportation of the item. For example, existing routes may be those that would result in less than five minutes (or, alternatively, two miles) being added to the existing route to transport the item. In some embodiments, this threshold may be established by the delivery system 100 and may be adjustable based on a quantity of routes identified. For example, the request servicing component 205 or the vehicle route control component 230 may establish the threshold such that at least a minimum number of routes is returned, where the minimum number of routes is adjustable. In some embodiments, from the 10 possible vehicles, a subset of three, or any other number, of vehicles may be identified as having existing routes that provide for efficient transport of the item. In some embodiments, the request servicing component 205 or the vehicle route control component 230 may determine that a most efficient route for one of the vehicles may include one or both of the pickup location and the delivery location on its existing route, which may increase likelihood of that vehicle being selected to transport the item.

At block 1025, the vehicle having the route that is the most efficient or requires the least change to transport the item is selected. In some embodiments, the selection of the vehicle from the subset is performed by the request servicing component 205. In some embodiments, the vehicle route control component 230 may select the vehicle from the subset. In some embodiments, the selection of the vehicle from the subset may also consider the item details and related constraints. After the vehicle is selected, the delivery system 100 may transmit the request to the vehicle if the vehicle is a third-party vehicle or update the vehicle route if the vehicle is a first-party vehicle.

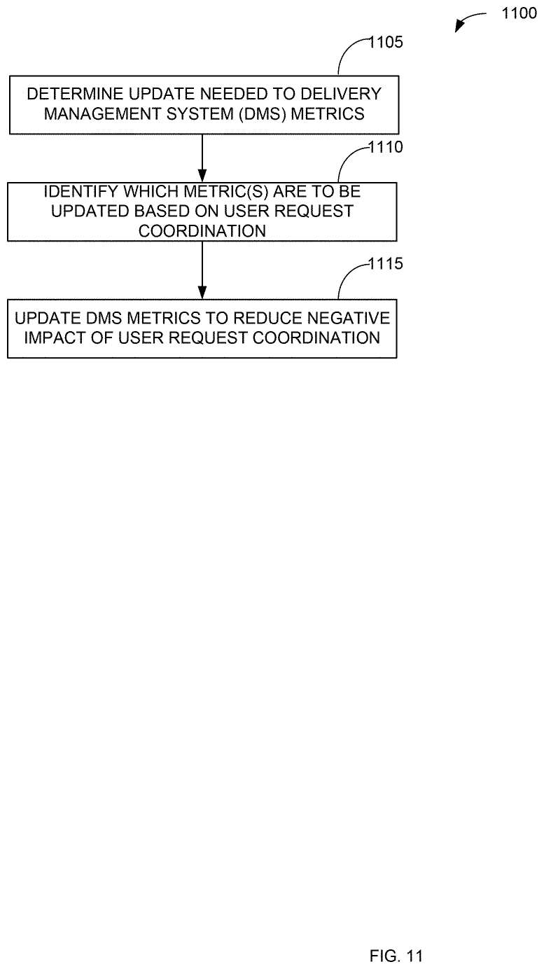

FIG. 11 is a flowchart of an exemplary method of updating delivery management system (DMS) metrics for a vehicle in the system.

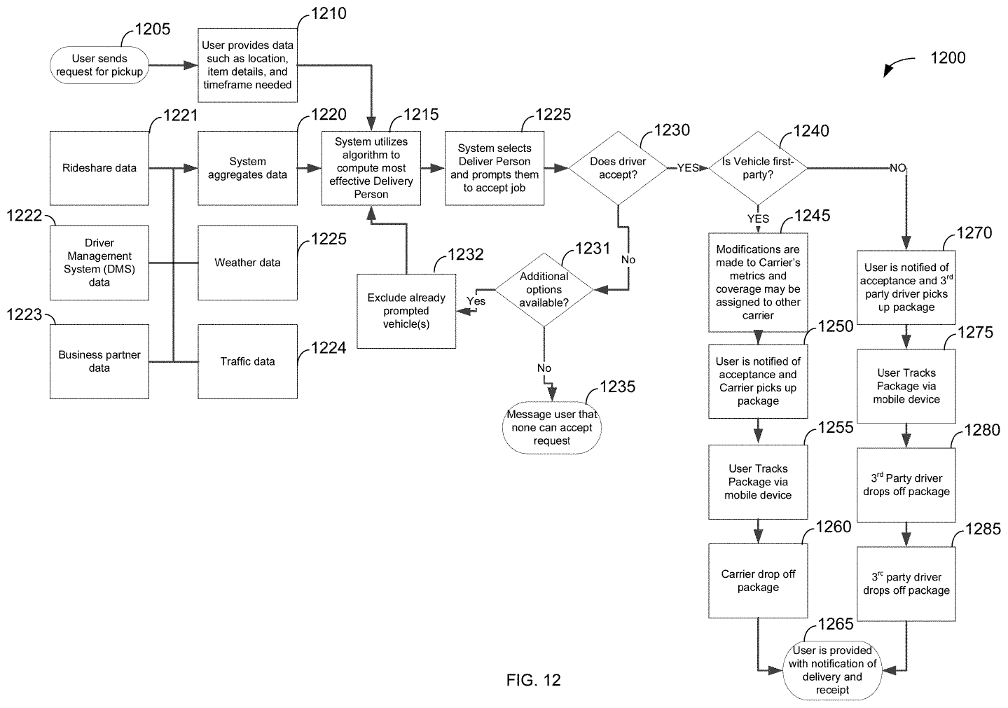

FIG. 12 is a flowchart of an exemplary method 1200 of handling a user request for localized transportation of an item. In some aspects, the method 1200 discussed below with respect to FIG. 12 may be performed by one or more of the components discussed above with respect to FIG. 2 or FIG. 7. In some aspects, the method 1200 may be performed by the delivery system 100, in general.

At block 1205, the delivery system 100 identifies an initiation of a request to transport an item. A user may initiate the request via an app or website on a phone, tablet, or computer (or similar computing device) that interfaces with the delivery system 100 or via a phone call to a call center or visit to a physical location associated with the delivery system 100. In some embodiments, the user may have a profile that is associated with the delivery system 100 or that can be associated with the delivery system 100 based on prior associations with the user.

As noted in block 1210, the user may provide, as part of the request, details of the item transport as well as information regarding the user and payment information. For example, the interface (for example, the app, phone call, and so forth) may include a request for payment information, where payment is automatically authorized if the delivery system 100 is able to fulfill the user's transportation request. In some embodiments, the request includes the pickup and/or delivery location information, pickup and/or delivery times (if pertinent), maximum transit time (if pertinent), and/or item details. In some embodiments, the item details may include dimensions of the item, weight of the item, any temperature or environmental requirements of the item, hazardous properties of the item, and/or any other transport restrictions that may exist (for example, fragile handling, susceptibility to jostling, etc.). These transportation restrictions may be classified as transportation constraints and may include additional restrictions not listed here.

The request may also include any quality (or ratings) requirement for the vehicle that transports the item that the user provides. In some embodiments, the item details in the request may also include a value of the item or a priority or urgency of the item. In some embodiments, additional item information may include details that change an importance or value of the item relative to other items. In some embodiments, the item details may include privacy constraints regarding the item. For example, the item may be contained in packaging that cannot be opened between pickup and delivery to ensure privacy of the user and other parties involved with the item transport.

In some embodiments, the user may request that a particular transport mode (for example, drone, bus, car, bicycle, etc.) or that a first delivery service (for example, FedEx, UPS, etc.) be used for transport of the item over a second delivery service (for example, Uber, Lyft, etc.).

At block 1215, the delivery system 100 may utilize an algorithm or one or more processes or methods to identify a most efficient or effective delivery vehicle. The information for accomplishing this is received from blocks 1220 and 1232. In some embodiments, at block 1220, the delivery system 100 aggregates information from first-party and third-party services and vehicles (such as ridesharing companies or courier services) at block 1221, data from the DMS for first-party vehicles at block 1222, business partner data at block 1223, traffic data at block 1224, and weather data 1225. As described herein, and according to the processes and methods disclosed, the delivery system 100 determines the most efficient and/or effective vehicle for transportation of the item according to the user request.

Block 1232 provides to block 1215 information regarding vehicles which have already been prompted so they will not be further considered in block 1215. The derivation of a list of previously prompted vehicles is accomplished in the manner disclosed hereinafter. In some embodiments, in block 1215, the delivery system 100 may prioritize one or more data in the algorithm or process/method used to identify the most efficient or effective delivery vehicle to identify which vehicle is best suited for the item transport. For example, if the item must be transported to its delivery location soon (based on a provided delivery time constraint), then the delivery system 100 may prioritize those vehicles that can pick up, transport, and deliver the item by the requested delivery time. Similarly, the delivery system 100 may prioritize transportation constraints or value of the item, which may impact and change the selection of the most efficient or effective vehicle. One or more other constraints or details of the item or request may be used to prioritize selection of the most efficient or effective vehicle for item transport. In some embodiments, when the user request includes a specific delivery service, selected vehicles may be filtered based on association with that specific delivery service.

At block 1225, the delivery system 100 selects the determined most efficient and/or effective vehicle and prompts the vehicle (and its operator) to accept the request to transport the item. In some aspects, if the vehicle (and its operator) are associated with the delivery system 100 (for example, are a first-party vehicle/operator), then the prompt may be a notification that they have been assigned to the transportation of the vehicle. In some embodiments, the prompt or notification may include one or more details of the transportation, including one or more of the pickup and/or delivery locations, details of the item that were provided, details of an predicted fee to be paid, timing constraints, and/or transportation constraints.

At block 1230, the delivery system 100 determines whether the prompted vehicle and operator accepts the request to transport the item. This determination may be made based on a response received from the vehicle and operator. If the response is negative, the process 1200 moves to block 1231.

At block 1231, the delivery system 100 determines whether additional options for vehicles to transport the item exist in the region. These options could include, for example, other available vehicles, options to delay delivery, and so forth. If it is determined in block 1231 that one or more options do exist, the process 1200 moves to block 1232.

At block 1232, the delivery system 100 excludes any vehicles and operators that have already been prompted to accept the request to transport the item and that have declined or not accepted the request. Once the vehicle(s) that declined to transport the item are excluded, the process 1200 moves to block 1215 wherein the delivery system 100 repeats the processing of method 1200 as discussed above.

If, in block 1231, it is determined that no additional options are available, the process 1200 moves to block 1235. At block 1235, the delivery system 100 generates and sends a message to the user that the item cannot be transported in the requested criteria based on a determination that no additional vehicles are available beyond those that did not accept the request to transport the item. In some embodiments, the delivery system 100 may include recommendations of criteria which may be more likely to be accepted for transport. In some embodiments, the delivery system 100, when no additional options are available, considers first- or third-party vehicles 110a and 110b that were previously excluded for one or more reasons. For example, if the delivery system 100 previously excluded a first-party vehicle 110a because of having worked too many hours and excessive overtime costs, the delivery system 100, now having no other options, reconsiders utilizing the excluded first-party vehicle 110a or other excluded vehicles to complete the user request. In some embodiments, reconsidering the excluded vehicles 110 is only performed if the priority of the user request exceeds a threshold level, indicating that the user request cannot wait until a vehicle non-excluded vehicle 110 becomes available. In some embodiments, reconsidering the excluded vehicles 100 is performed for all user requests, regardless of the priority of the user request.

In block 1230, if the driver does accept, the process 1200 moves to block 1240. At block 1240, if the delivery system 100 determines that the prompted vehicle and operator do accept the request, then the delivery system 100 determines whether the vehicle is a first-party or a third-party vehicle. In some embodiments, the determination made at block 1240 may be made before the vehicle is prompted at block 1225. In some embodiments, the determination as to whether the vehicle is a first-party or third-party vehicle is made by reviewing the association field 311 for the selected vehicle. If it is determined that the vehicle is a first-party vehicle, the process 1200 moves to block 1245.

At block 1245, the delivery system 100 modifies the DMS metrics associated with the selected vehicle when the delivery system 100 determines that the prompted vehicle is a first-party vehicle at block 1240. In some embodiments, the delivery system 100 may update a route of the selected vehicle with details of the transport of the item. In some embodiments, updating the route of the selected vehicle may include assigning one or more tasks or deliveries to another vehicle. In some embodiments, updating the route of the selected vehicle may include inserting waypoints or additional destinations into the existing route. At block 1250, the delivery system 100 may notify the user of acceptance of the transport request by the vehicle. At block 1250, the delivery system 100 may also instruct the vehicle to pick up the item. Once the item is picked up, the delivery system 100 may update an inventory of the vehicle to include the item, and the system may provide the vehicle with an updated route that includes the transportation of the item. The notification may be made via a confirmation which includes details of that vehicle for which the vehicle or the operator which agreed to transport the item. Such details may include one or more of the vehicle ID, description of the vehicle, estimated costs, estimated pickup, delivery, and transit times, route information, etc. In some embodiments, the confirmation may include tracking information with which the user may track the status of the vehicle and/or the item being transported. For example, the user may use the tracking information to determine when the vehicle will arrive at the pickup location and where the vehicle is along its delivery route.

At block 1255, the delivery system 100 may provide tracking information to the user for use in tracking the item. The tracking information may be provided via the app or via one or more electronic communication methods. In some embodiments, the tracking information may include relative locations of the vehicle while the vehicle is transporting the item. In some embodiments, the tracking information may include time and location of pickup and delivery as well as details of who received the item or provided the item to the vehicle.

At block 1260, the delivery system 100 may instruct the vehicle to deliver the item once the vehicle arrives at the delivery location.

At block 1265, the user is provided with confirmation of delivery and receipt by a recipient.

If, in block 1240, it is determined that the vehicle is not a first-party vehicle, the process 1200 moves to block 1270. At block 1270, the delivery system 100 may notify the user of acceptance of the transport request by the third-party vehicle. At block 1250, the delivery system 100 may also instruct the third-party vehicle to pick up the item. Once the item is picked up, the delivery system 100 may update an inventory of the third-party vehicle to include the item and the delivery system 100 may provide the third-party vehicle with an updated route that include the transportation of the item. The notification may be made via a confirmation which includes details of the third-party vehicle that agreed to transport the item. Such details may include one or more of the vehicle ID, description of the third-party vehicle, estimated costs, estimated pickup, delivery, and transit times, route information, etc. In some embodiments, the confirmation may include tracking information with which the user may track the status of the third-party vehicle and/or the item being transported. For example, the user may use the tracking information to determine when the third-party vehicle will arrive at the pickup location and where the vehicle is along its delivery route.

At block 1275, the delivery system 100 may provide tracking information to the user for use in tracking the item. The tracking information may be provided via the app or via one or more electronic communication methods. In some embodiments, the tracking information may include relative locations of the third-party vehicle while the third-party vehicle is transporting the item. In some embodiments, the tracking information may include time and location of pickup and delivery as well as details of who received the item or provided the item to the third-party vehicle.

At block 1280, the delivery system 100 may instruct the third-party vehicle to deliver the item once the third-party vehicle arrives at the delivery location.

At block 1265, the user is provided with confirmation of delivery and receipt by a recipient.

Those of skill will recognize that the various illustrative logical blocks, modules, circuits, and algorithm steps described as follows, and in connection with the embodiments disclosed herein may be implemented as electronic hardware, software stored on a computer readable medium and executable by a hardware processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor reads information from, and write information to, the storage medium. In the alternative, the storage medium may be integral to the processor. The processor and the storage medium may reside in an ASIC.

While the above detailed description has shown, described, and pointed out novel features of the development as applied to various embodiments, it will be understood that various omissions, substitutions, and changes in the form and details of the device or process illustrated may be made by those skilled in the art without departing from the spirit of the development. As will be recognized, the present development may be embodied within a form that does not provide all of the features and benefits set forth herein, as some features may be used or practiced separately from others. All changes which come within the meaning and range of equivalency of the claims are to be embraced within their scope.

A person skilled in the art will recognize that each of these sub-systems may be inter-connected and controllably connected using a variety of techniques and hardware and that the present disclosure is not limited to any specific method of connection or connection hardware.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, a microcontroller or microcontroller based system, programmable consumer electronics, network PCs, minicomputers, mainframe computers, distributed computing environments that include any of the above systems or devices, and the like.

As used herein, instructions refer to computer-implemented steps for processing information in the system. Instructions may be implemented in software, firmware or hardware and include any type of programmed step undertaken by components of the system. As also used herein, the term component may be used and/or implemented in software, firmaware, or hardware, and/or may comprise its own circuit.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX®, MacOS® or Microsoft Windows®.

The system control may be written in any conventional programming language such as C, C++, BASIC, Pascal, .NET (e.g., C #), or Java, and ran under a conventional operating system. C, C++, BASIC, Pascal, Java, and FORTRAN are industry standard programming languages for which many commercial compilers may be used to create executable code. The system control may also be written using interpreted languages such as Perl, Python or Ruby. Other languages may also be used such as PHP, JavaScript, and the like.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

As will be understood by those of skill in the art, in some embodiments, the processes set forth in the following material may be performed on a computer network. The computer network having a central server, the central server having a processor, data storage, such as databases and memories, and communications features to allow wired or wireless communication with various parts of the networks, including terminals and any other desired network access point or means.

What is claimed is:

1. A method of coordinating item delivery, comprising:
receiving a request to transport an item, the request including at least one of a pickup location and a delivery location;
identifying a delivery vehicle of a plurality of delivery vehicles based on a proximity of the delivery vehicle to the pickup location;
determining whether the identified delivery vehicle is associated with a first delivery service or a second delivery service;
when the identified delivery vehicle is associated with the first delivery service:
generating a notification to the identified delivery vehicle that the pickup location has been added to an itinerary of the identified delivery vehicle, and
updating a routing of the identified vehicle based on the pickup location and the delivery location;
when the identified delivery vehicle is associated with the second delivery service:
generating a first inquiry to the identified vehicle requesting confirmation that the identified vehicle will transport the item, and
receiving a response to the first generated inquiry; and
generating a confirmation including an identifier of the identified delivery vehicle.

2. The method of claim 1, wherein the request further indicates one or more of: an urgency or priority of the item; a requested delivery time for the item; transportation constraints for the item; and a value of the item.

3. The method of claim 2, wherein the transportation constraints for the item include: a size of the item; a weight of the item; environmental constraints of the item; and privacy constraints of the item.

4. The method of claim 3, wherein identifying the delivery vehicle is further based on filtering the plurality of delivery vehicles according to at least one of the urgency or priority of the item, the requested delivery time for the item, the transportation constraints for the item, and the value of the item.

5. The method of claim 1, wherein the request further includes a selection of the first delivery service or the second delivery service and wherein identifying the delivery vehicle is further based on the selection of the first or second delivery service.

6. The method of claim 4, wherein when the selection identifies the first delivery service, the identified delivery vehicle is identified from a first subset of the plurality of delivery vehicles, the first subset including only vehicles associated with the first delivery service, and when the selection identifies the second delivery service, the identified delivery vehicle is identified from a second subset of the plurality of delivery vehicles, the second subset including only vehicles associated with the second delivery service.

7. The method of claim 1, wherein identifying the delivery vehicle further comprises identifying one or both of the pickup location and the delivery location along a route of the identified delivery vehicle.

8. The method of claim 1, wherein the response includes a rejection indicating that the identified delivery vehicle rejects the inquiry and, further comprising, in response to the received rejection:
identifying a second delivery vehicle of the plurality of delivery vehicles based on a proximity of the second delivery vehicle to the pickup location;
determining whether the second identified delivery vehicle is associated with the first delivery service or the second delivery service;
when the second identified delivery vehicle is associated with the first delivery service:
generating a notification to the second identified delivery vehicle that the pickup location has been added to an itinerary of the second identified delivery vehicle, and
updating a routing of the second identified vehicle based on the pickup location and the delivery location;
when the second identified delivery vehicle is associated with the second delivery service:
generating a second inquiry to the second identified vehicle requesting confirmation that the second identified vehicle will transport the item, and
receiving a second response to the second generated inquiry.

9. The method of claim 1, further comprising generating location updates for the identified delivery vehicle before and after pickup of the item.

10. The method of claim 1, further comprising determining a minimum deviation route of the identified delivery vehicle based on an original route of the identified delivery vehicle and updating the original route to include the minimum deviation route.

11. A system for coordinating item delivery, the system comprising:
a communication component configured to receive a request to transport an item, the request including at least one of a pickup location and a delivery location;
a processor circuit configured to:
identify a delivery vehicle of a plurality of delivery vehicles based on a proximity of the delivery vehicle to the pickup location;
determine whether the identified delivery vehicle is associated with a first delivery service or a second delivery service;
when the identified delivery vehicle is associated with the first delivery service:
generate a notification to the identified delivery vehicle that the pickup location has been added to an itinerary of the identified delivery vehicle, and
update a routing of the identified vehicle based on the pickup location and the delivery location;
when the identified delivery vehicle is associated with the second delivery service:
generate a first inquiry to the identified vehicle requesting confirmation that the identified vehicle will transport the item, and receiving a response to the first generated inquiry; and
generate a confirmation including an identifier of the identified delivery vehicle.

12. The system of claim 11, wherein the request further indicates one or more of: an urgency or priority of the item; a requested delivery time for the item; transportation constraints for the item; and a value of the item.

13. The system of claim 12, wherein the transportation constraints for the item include: a size of the item; a weight of the item; environmental constraints of the item; and privacy constraints of the item.

14. The system of claim 13, wherein the processor circuit configured to identify the delivery vehicle comprises the processor circuit configured to filter the plurality of delivery vehicles according to at least one of the urgency or priority of the item, the requested delivery time for the item, the transportation constraints for the item, and the value of the item.

15. The system of claim 11, wherein the request further includes a selection of the first delivery service or the second delivery service and wherein identifying the delivery vehicle is further based on the selection of the first or second delivery service.

16. The system of claim 15, wherein when the selection identifies the first delivery service, the identified delivery vehicle is identified from a first subset of the plurality of delivery vehicles, the first subset including only vehicles associated with the first delivery service, and when the selection identifies the second delivery service, the identified delivery vehicle is identified from a second subset of the plurality of delivery vehicles, the second subset including only vehicles associated with the second delivery service.

17. The system of claim 11, wherein the processor circuit configured to identify the delivery vehicle comprises the processor circuit configured to identify one or both of the pickup location and the delivery location along a route of the identified delivery vehicle.

18. The system of claim 11, wherein the response includes a rejection indicating that the identified delivery vehicle rejects the inquiry and wherein the processor circuit is further configured to, in response to the received rejection:
identify a second delivery vehicle of the plurality of delivery vehicles based on a proximity of the second delivery vehicle to the pickup location;
determine whether the second identified delivery vehicle is associated with the first delivery service or the second delivery service;
when the second identified delivery vehicle is associated with the first delivery service:
generate a notification to the second identified delivery vehicle that the pickup location has been added to an itinerary of the second identified delivery vehicle, and
updating a routing of the second identified vehicle based on the pickup location and the delivery location;
when the second identified delivery vehicle is associated with the second delivery service:
generating a second inquiry to the second identified vehicle requesting confirmation that the second identified vehicle will transport the item, and
receiving a second response to the second generated inquiry.

19. The system of claim 11, wherein the processor circuit is further configured to generate location updates for the identified delivery vehicle before and after pickup of the item.

20. The system of claim 11, wherein the processor circuit is further configured to determine a minimum deviation route of the identified delivery vehicle based on an original route of the identified delivery vehicle and updating the original route to include the minimum deviation route.
